(19) United States
(12) Patent Application Publication
(10) Pub. No.: US 2025/0303282 A1
(43) Pub. Date: Oct. 2, 2025

(54) SYSTEMS AND METHODS FOR MODULATING DYNAMICS OF MULTIUSER EVENTS

(71) Applicant: Adeia Guides Inc., San Jose, CA (US)

(72) Inventors: Aldis Sipolins, Sommerville, MA (US); Tao Chen, Palo Alto, CA (US); Jean-Yves Couleaud, Mission Viejo, CA (US)

(21) Appl. No.: 18/621,423

(22) Filed: Mar. 29, 2024

(51) Int. Cl. A63F 13/46

(52) U.S. Cl. CPC A63F 13/46; A63F 2300/61; A63F 2300/8023

(57) ABSTRACT

Methods and systems are provided to improve user engagement with a multiuser event by actively driving the dynamics of the multiuser event. To do so, a server monitors, during an ongoing multiuser event, the difference between an actual performance dynamics (APD) score associated with avatars participating in the multiuser event and a set performance dynamics (SPD) score that serves as a guide for the APD score. When this difference exceeds a threshold, at least one subset of avatars participating in the multiuser event, e.g., a team can be modulated by e.g., modifying e.g., the composition of the at least one subset, a skill score of at least one avatar of the at least one subset or a participation level of at least one avatar of the at least one subset so as to reduce the difference between the APD score and the SPD score.

### BACKGROUND

The present disclosure relates to methods and systems for improving efficiency of resource usage associated with hosting online live multiuser events. More particularly, but not exclusively, the present disclosure relates to methods and systems, implemented by a server, for improving engagement, within a multiuser event, of users controlling avatars participating in the online live multiuser event.

### SUMMARY

Online live multiuser events have a certain number of participating avatars, each controlled by a participating user, in conjunction with a lobby or a queue accommodating non-participating avatars, each controlled by a non-participating user, able to become participating avatars under given circumstances.

In some approaches, prior to the start of an online live multiuser event, the multiuser event server may select, initially, one or more available avatars to form opposing groups of participating avatars having similar abilities, e.g., so as to establish a balance of abilities between opposing groups and maximize an uncertainty level of the outcome of the online live multiuser event. An avatar may be associated automatically with a respective participating user. If there were an imbalance of abilities between opposing groups, this may result in favoring one of the opposing groups, and the favored opposing group would likely better perform during the online live multiuser event than the disadvantaged opposing group. At any time during an online live multiuser event, a participating user (and thus the avatar they control) can leave the online live multiuser event, without any preliminary warning about their imminent departure for the other participating users, the non-participating users, or the multiuser event host. A participating user might leave an online live multiuser event for various reasons. For instance, the departing user controlling the departing avatar may not engage with the online live multiuser event as they are not sufficiently entertained by the online live multiuser event. Or the departing user controlling the departing avatar may be unsatisfied by the real-time outcome of the online live multiuser event. Alternatively, the departing user controlling the departing avatar may have exceeded the time they allocated to attend the online live multiuser event.

In some approaches involving a lobby, when a participating user leaves an online live multiuser event, the online live multiuser event is paused to prevent the outcome of the online live multiuser event from being affected by the leaving of the participating user and of the participating avatar they control. During the pause, the multiuser event host server may select a non-participating avatar from the lobby to replace the participating avatar leaving the online live multiuser event and check for their availability. The selection of the non-participating avatar to replace the leaving participating avatar may be based on e.g., the order of arrival of the non-participating avatars in the lobby, their availability, the similarity of the characteristics between the leaving participating avatar and the selected non-participating avatar, etc. A pause during an online live multiuser event may represent a wastage of resources (e.g., network resources, processing resources and energy to run them) but allow for maintaining the balance of abilities, established prior to the start of the online live multiuser event, between opposing groups, if the lobby contains non-participating avatars (controlled by non-participating users).

In some examples, the balance of abilities established prior to the start of the multiuser event between opposing groups may favor one of the opposing groups. The users controlling the participating avatars of the disadvantaged opposing group may become first frustrated, then disengaged with the online live multiuser event, triggering escalating user replacements and/or pauses, thereby lengthening and/or interrupting the online live multiuser event. The users controlling the advantaged opposing group may also become bored due to the lack of challenge and/or the number of pauses disrupting the online live multiuser event, and may leave the online live multiuser event too, causing more pauses. The departure of participating users controlling avatars from both opposing groups may ultimately turn the online live multiuser event into an empty or near-empty multiuser event, that may be ended by the multiuser event host server to avoid prolonging this unpleasant experience for the participating users who did not depart.

In the absence of a non-participating avatar having abilities similar to those of a participating avatar leaving the multiuser event, the balance of abilities between opposing groups cannot be achieved after a replacement, leading to user disengagement, user replacements and associated pauses disrupting the online live multiuser event, which may ultimately end before becoming an empty or near-empty event.

Users (or avatars) leaving the online live multiuser event, e.g., because of dissatisfaction, may join other online live multiuser events concomitant with the online live multiuser event they left or online live multiuser events newly generated, e.g., by the multiuser event host server. This dynamic (e.g., the leaving, joining and/or generation of multiuser events) may play out across numerous online live multiuser events as users “hop” between multiuser events. It is desirable to limit or avoid such practice, as it may lead to multiuser event host servers hosting and facilitating an increased number of online live multiuser events, resulting in an inefficient use of resources. For example, improving user engagement with an existing multiuser event may minimize resource used, facilitating users to hop between events and/or generate new multiuser events; additionally, available resource may be assigned to an existing multiuser event, thereby improving the operation of that multiuser event.

In other approaches involving a queue, when a participating user (and thus the avatar they control) leaves an online live multiuser event, a non-participating avatar (controlled by a non-participating user) from the queue takes the place of the participating avatar leaving the online live multiuser event, e.g., on a first-come-first-served basis. There is thus no break (or at least no break perceivable to a user) in the multiuser event. In some examples, the replacement of a participating avatar by a non-participating avatar is independent of the similarity of their respective characteristics, which may cause the balance of abilities between opposing groups (if ever achieved prior to the start of the online live multiuser event) to evolve during the online live multiuser event into an imbalance of abilities favoring either of the opposing groups, without any control to select which opposing group to favor. This imbalance of abilities between the opposing groups may result in the aforementioned vicious circle: frustration of the participating users controlling each a participating avatar, user disengagement from the multiuser event, escalating replacements of participating avatars by non-participating avatars, migrations of participating users towards other concomitant or newly generated online live multiuser events and ending of deserted online live multiuser events, while precious resources are squandered.

In other approaches involving a queue, when a participating user (and thus the avatar they control) leaves an online live multiuser event, a non-participating avatar (controlled by a non-participating user) from the queue takes the place of the participating avatar leaving the online live multiuser event, e.g., by selecting a non-participating avatar whose characteristics are similar to the characteristics of the participating avatar that is departing. This results in maintaining the balance of abilities, established prior to the online live multiuser event, between opposing groups throughout the online live multiuser event if it appears to be a balance of abilities during the online live multiuser event. However, if it appears to be an imbalance of abilities during the online live multiuser event, this results in maintaining an imbalance of abilities between opposing groups throughout the online live multiuser event, without having the possibility to turn this imbalance of abilities between opposing groups into a balance of abilities between opposing groups.

The aforementioned approaches indeed fail to actively control the difference of performance between opposing groups, throughout the duration of an online live multiuser event, to drive, in real-time, the outcome of the multiuser event, in order to maximize user engagement with the multiuser event. Additionally, the maximization of the user engagement with the multiuser event would lead to the minimization of user churn, pauses (if established in the multiuser event) and number of simultaneous online live multiuser events, while minimizing the use of precious resources required to host online live multiuser events. As a result, there is a need for methods and systems able to achieve or at least near the above objectives.

Methods and systems, implemented by a server, are provided herein for improving the engagement, with the multiuser event, of participating users controlling each an avatar throughout the duration of online live multiuser events, regardless of whether or not users are leaving or joining the online live multiuser events. In some embodiments, the server monitors, while a multiuser event is ongoing, an actual performance dynamics (APD) score associated with avatars participating in the multiuser event. In some embodiments, additionally, the server determines that a difference between the APD score associated with the avatars participating in the multiuser event and a set performance dynamics (SPD) score is outside of a threshold. In some embodiments, furthermore, based on the difference between the APD score and the SPD score being outside of the threshold, the server modulates at least one subset of avatars participating in the multiuser event to cause a reduction in the difference between the APD score associated with the avatars participating in the multiuser event and the SPD score.

Hereby, the server is able to maintain, throughout the duration of an online live multiuser event, the engagement with the multiuser event, of users participating in the multiuser event by carefully modifying, when needed, the at least one subset of avatars participating in the multiuser event (e.g., in terms of composition, skills—type thereof or level thereof—of an avatar of the at least one subset of avatars participating in the multiuser event or participation level) so as to drive the multiuser event dynamics. This reduces the number of pauses (when relevant) and the number of simultaneously ongoing multiuser events (e.g., online live multiuser events) by avoiding the migration of users participating in a multiuser event into newly-generated multiuser events that are spawned to accommodate them, besides providing a more pleasant experience for the users controlling each an avatar by e.g., minimizing the time spent with imbalanced teams. An at least one subset of avatars participating in the multiuser event (e.g., a subset of avatars participating in the multiuser event) represents e.g., a team, a squad or a group, whose aim is to win a multiuser event (e.g., online live multiuser event) when competing against another subset of avatars participating in the multiuser event, wherein each avatar of the other subset of users participating in the multiuser event is controlled by e.g., a user participating in the multiuser event or control circuitry of a server (e.g., multiuser event host server).

In some examples, the curve representing the APD score associated with the avatars participating in the multiuser event against the time of a multiuser event indicates, at any time, which subset of avatars participating in the multiuser event dominates another subset of avatars participating in the multiuser event. In some examples, the curve representing the SPD score against the time of a multiuser event serves as a guide for the curve representing the APD score against the time of a multiuser event to maintain the engagement, with the multiuser event, of participating users controlling each a participating avatar throughout the duration of a multiuser event. In some examples, the threshold represents an acceptable difference between the APD score associated with the avatars participating in the multiuser event and the SPD score.

Hereinafter, the term ‘participating user’ or ‘user participating in a multiuser event’ should be understood to mean a user (e.g., an individual) controlling an avatar able to perform actions to influence the outcome of the multiuser event (e.g., an online live multiuser event). In some examples, an individual controls, e.g., selectively controls, one or more avatars in the multiuser event, e.g., one or more avatars on a team of participating avatars. The term ‘user’ should be understood to mean a human being associated with a user account for accessing the multiuser event and controlling one or more avatars. Each user enters credentials in a multiuser event interface so as to access metadata related to one or more avatars they wish to control. To each participating user corresponds at least one avatar participating in the multiuser event: the at least one avatar is able to perform actions to influence the outcome of the multiuser event based on their actual performance during the multiuser event. The terms ‘avatar participating in a multiuser event’ or ‘participating avatar’ are interchangeable.

In some examples, each avatar is associated e.g., automatically associated with a respective participating user. For instance, a participating user is associated with a default avatar when participating in an online live multiuser event. For instance, a participating user is associated with an avatar of David Beckham when participating in an online live soccer match, the avatar of David Beckham not being controllable outside of the context of the online live soccer match. In other instances, a user has a custom avatar configured for participation in an online event, such as the game Fortnite.

In some examples, each avatar is associated e.g., already associated with multiple different users. For example, a user logs out of the multiuser event (or moves to a lobby, queue or other area of the multiuser event) thereby relinquishing control of an avatar, and another user logs in to the multiuser event and/or joins from a lobby/queue to gain control of the avatar whose control has been relinquished. For instance, a first user may control an avatar in an online battle for a certain period. Upon completion of that period, control of that avatar may be switched to a second user (different from the first user). In some examples, the switch in control may be effected automatically by control circuitry, e.g., of a server implementing the multiuser event, or as a result of a user selecting to leave or cease participating in the multiuser event.

In some examples, each avatar of a first plurality of avatars participating in a multiuser event is associated with a respective participating user and each avatar of a second plurality of avatars participating in the multiuser event is associated with multiple different participating users. For instance, multiple participating users control each their own avatar while several participating users control, at different times, each e.g., the David Beckham avatar. Alternatively, multiple participating users control each their own avatar while several participating users control each, simultaneously, a David Beckham avatar.

Hereinafter, the term ‘non-participating user’ or ‘user non-participating in a multiuser event’ should be understood to mean a user not having control of an avatar in the multiuser event (e.g., an online live multiuser event), thus being unable to perform actions able to influence the outcome of the multiuser event. For instance, the term ‘non-participating user’ or ‘user non-participating in a multiuser event’ can refer to a user who has control of an avatar, but does not involve the avatar in the multiuser event (e.g., an online live multiuser event), e.g., by virtue of entering the avatar into a waiting room, e.g., lobby, queue or lobby/queue hybrid associated with the multiuser event. In some examples, a non-participating user becomes a participating user by taking control of an avatar able to influence the outcome of the multiuser event through the actions the avatar performs during the multiuser event. For example, a user takes over control of an avatar involved, e.g., currently or actively involved, in an online battle, thereby becoming a participating user. Alternatively, a user involves a new avatar in an online battle, thereby becoming a participating user. To each non-participating user corresponds at least one avatar non-participating in the multiuser event: the at least one avatar is located in a waiting room e.g., lobby, queue or lobby/queue hybrid and is unable to perform actions to influence the outcome of the multiuser event based on their actual performance during the multiuser event. The terms ‘avatar non-participating in a multiuser event’ or ‘non-participating avatar’ are interchangeable.

The users participating in the multiuser event control the participating avatars via a user device (e.g., a computer, tablet, mobile phone, TV with a remote control, TV with a console, etc.) in communication with a server hosting a plurality of online live multiuser events, via a communication network (e.g., local network or remote network). In some approaches, prior to the start of the multiuser event, the server gathers the avatars participating in the multiuser event into at least one subset of avatars participating in the multiuser event e.g., based on historical metadata of the avatars participating in the multiuser event when controlled by respective users. In some instances, the historical metadata of each avatar participating in the multiuser event comprise e.g., a series of curves (e.g., continuous or discontinuous), related to past multiuser events similar to the upcoming multiuser event, each curve representing the individual actual performance dynamics (IAPD) score of a single avatar (when controlled by a specific user) against the time of a past multiuser event. Hereinafter, IAPD scores related to a past multiuser event are referred to as individual historical performance dynamics (IHPD) score. For each avatar of the at least one subset of avatars participating in the multiuser event, the server averages the IHPD scores (retrieved from each curve representing the IHPD score of an avatar of the at least one subset of avatars participating in the multiuser event against the time of a past multiuser event when the avatar is controlled by a specific user) mapped to a given time point so as to obtain the curve representing the averaged IHPD score against the time of a past multiuser event. In some instances, for each avatar of the at least one subset of avatars participating in the multiuser event, the server takes into account the most recent curves representing the IHPD score against the time.

In some instances, prior to the start of the multiuser event, due to the insufficient number of avatars present in the lobby/queue hybrid (which requires no pause and relies on the selection of avatars based on the characteristics of the avatars that are to participate in the multiuser event, e.g., on the IHPD score of the avatars that are to participate in the multiuser event), the server forms only a single subset of avatars participating in the multiuser event based on the avatars from the lobby/queue hybrid. In some instances, additionally, the server generates another subset of avatars participating in the multiuser event, whose performance during the multiuser event is managed by a machine learning model controlled by the server. Both subsets of avatars participating in the multiuser event (irrespective of whom controls the avatars participating in the multiuser event) compete against each other.

In some instances, the server selects avatars present in the lobby/queue hybrid to form two opposing subsets of avatars participating in the multiuser event, based on the curves representing the IHPD scores of the selected avatars against the time of past multiuser events. For each avatar of the two opposing subsets of avatars participating in the multiuser event, the server averages the IHPD scores of an avatar of one of the two opposing subsets mapped to a given time point so as to obtain the curve representing the averaged IHPD score against the time of a past multiuser event. In some instances, for each avatar of the at least one subset of avatars participating in the multiuser event, the server takes into account the most recent curves representing the IHPD score against the time.

Additionally or alternatively, the historical metadata of each avatar participating in the multiuser event (when controlled by a specific user) comprise e.g., the start time and end time of each past session during which each user controlling an avatar participating in a multiuser event attended one or more multiuser events, the duration of each past session, the amount of multiuser events (per past session) each user controlling an avatar participating in a multiuser event attended, so as to determine the possible number of multiuser events each user controlling an avatar participating in a multiuser event is going to play during the pending session. Additionally or alternatively, the historical metadata of each avatar participating in the multiuser event (when controlled by a specific user) comprise e.g., the outcome of each past multiuser event in which each avatar participated. In some instances, the server can place avatars (to participate in an upcoming multiuser event) controlled by users, e.g., having lately experienced a number of consecutive unfavorable outcomes, into a subset of avatars participating in the upcoming multiuser event presenting overall a high past performance based on high IHPD scores. This allows for these users to likely experience a favorable outcome, at the very least, during the initial part of the upcoming multiuser event, so as to boost their competition spirit. In some instances, the server can place avatars (to participate in an upcoming multiuser event) controlled by users e.g., having lately experienced a number of consecutive favorable outcomes, into a subset of avatars participating in the upcoming multiuser event presenting overall a low past performance based on low IHPD scores. This allows for these users to likely experience an unfavorable outcome, at the very least, during the initial part of the upcoming multiuser event, so as to create a challenge.

In some approaches, prior to the start of the multiuser event, the server selects a curve representing the SPD score against the time of a multiuser event among a plurality of predefined curves representing the SPD score against the time of a multiuser event, based on e.g., the historical metadata of the avatars participating in the multiuser event when each participating avatar is controlled by a specific user. The curve representing the SPD score against the time of a multiuser event describes the relationship between two distinct subsets of avatars participating in the multiuser event. At a time t, this relationship could be of dominance of one subset of avatars participating in the multiuser event over the other subset of the avatars participating in the multiuser event (both subsets are distinct from each other and do not share a same avatar participating in the multiuser event), or of equality between the two distinct subsets of avatars participating in the multiuser event. In some instances, prior to the start of the multiuser event, the server selects a curve representing the SPD score against the time of a multiuser event among a plurality of predefined curves representing the SPD score against the time of a multiuser event, based on e.g., the IHPD scores of each avatar of the at least one subset of avatars participating in the multiuser event and the type (e.g., favorable or unfavorable) and number of consecutive outcomes of recent past multiuser events. In some instances, the server adjusts the selected curve representing the SPD score against the time of a multiuser event based on the curves representing the average of IHPD scores of each avatar of the at least one subset of avatars participating in the multiuser event against the time of a multiuser event. In some instances, to obtain a SPD curve against the time of a multiuser event, the server averages the curves representing the average IHPD score of each avatar of a first subset of users participating in the multiuser event against the time of a multiuser event; the server then averages the curves representing the average IHPD score of each avatar of a second subset of avatars participating in the multiuser event against the time of a multiuser event (wherein the first subset is different from the second subset). The server finally subtracts the average IHPD score-related curve of the second subset from the average IHPD score-related curve so as to obtain the SPD score-related curve. In some instances, to obtain a SPD curve against the time of a multiuser event, the server determines a weighted average of the curves representing the average IHPD score of each avatar of a first subset of users participating in the multiuser event against the time of a multiuser event; the server then generates a weighted average of the curves representing the average IHPD score of each avatar of a second subset of avatars participating in the multiuser event against the time of a multiuser event (wherein the first subset is different from the second subset). The server finally subtracts the weighted average IHPD score-related curve of the second subset from the weighted average IHPD score-related curve so as to obtain the SPD score-related curve. In some instances, a machine learning model controlled by the server determines the SPD score-related curve.

The curve representing the SPD score against the time of a multiuser event serves as a guide for the curve representing the APD score against the time of a multiuser event to maintain the engagement, with the multiuser event, of users controlling each a participating avatar throughout the duration of a multiuser event. In some approaches, the server selects, during the multiuser event, an alternative curve representing the SPD score against the time of a multiuser event if the engagement, with the ongoing multiuser event, of users for the time left of the ongoing multiuser event is low (e.g., multiple participating avatars departing due to reasons other than the end of the session of the users controlling the multiple participating avatars).

In some approaches, the server monitors, during a multiuser event, the APD score associated with the avatars participating in the multiuser event. In some instances, the server determines the APD score associated with the avatars participating in the multiuser event at multiple time points scattered throughout the duration of the multiuser event. In some instances, due to the lack of non-participating avatars in the lobby/queue hybrid, the server forms a single subset of avatars participating in the multiuser event (wherein each of the avatars of the single subset is controlled by a user) and generates another subset of avatars participating in the multiuser event, whose performance is managed by a machine-learning model controlled by the server. Both subsets of avatars participating in the multiuser event (irrespective of the nature of whom controls the avatars participating in the multiuser event) compete against each other. The curve representing the APD score associated with the avatars participating in the multiuser event against the time of the multiuser event is located in the positive ordinates when the subset of the avatars participating in the multiuser event dominates the other subset (controlled by the server) of the avatars participating in the multiuser event: the higher the positive ordinates, the more performant is the subset of the avatars participating in the multiuser event, compared to the other subset of the avatars. And reciprocally, the curve representing the APD score against the time of the multiuser event is located in the negative ordinates when the other subset (controlled by the server) of the avatars participating in the multiuser event dominates the subset of the avatars participating in the multiuser event: the lower the negative ordinates, the more performant is the other subset (controlled by the server) of the avatars participating in the multiuser event compared to the subset of the avatars.

In some instances, when there are enough avatars participating in the multiuser event, the server forms two subsets of avatars participating in the multiuser event, wherein both subsets of avatars participating in the multiuser event are distinct from each other e.g., no avatar is shared by both subsets of avatars participating in the multiuser event. Both subsets of avatars participating in the multiuser event compete against each other. The curve representing the APD score associated with the avatars participating in the multiuser event against the time of the multiuser event is located in the positive ordinates when a subset of the avatars participating in the multiuser event dominates another subset of the avatars participating in the multiuser event: the higher the positive ordinates, the more performant is the subset of the avatars participating in the multiuser event, compared to the other subset of the avatars. And reciprocally, the curve representing the APD score associated with the avatars participating in the multiuser event against the time of the multiuser event is located in the negative ordinates when the other subset of the avatars participating in the multiuser event dominates the subset of the avatars participating in the multiuser event: the lower the negative ordinates, the more performant is the other subset of the avatars participating in the multiuser event compared to the subset of the avatars.

In some approaches, the server monitors, at a time point during the multiuser event, the APD score associated with the avatars participating in the multiuser event based on the IAPD scores, mapped to the time point, of each avatar participating in the multiuser event. In some instances, the server monitors, at a time point during the multiuser event, the APD score associated with the avatars participating in the multiuser event by summing the IAPD scores, mapped to the time point, of each avatar participating in the multiuser event. The IAPD scores of a subset of the avatars participating in the multiuser event and the IAPD scores of another subset of the avatars participating in the multiuser event (wherein both subsets of avatars participating in the multiuser event are distinct from each other e.g., no avatar is shared by both subsets of avatars participating in the multiuser event) are of opposite signs. At a time point, the APD score associated with the avatars participating in the multiuser event can consequently be positive, null or negative. In some approaches, the server determines the IAPD score of each avatar participating in the multiuser event by identifying multiuser event-dependent metrics used for determining the multiuser event dynamics. If the multiuser event is a match of a soccer video game, the metrics may be e.g., scored goals, goal attempts, ball ownership (e.g., time spent controlling the ball), field occupancy (e.g., time spent on the other team's side), successful passing rate (e.g., passing the ball between teammates), successful ball retrieving rate (e.g., stealing the ball from an opponent), amount and types of fouls, red card, yellow card, etc. If the multiuser event is a shooter video game match, metrics can be e.g., amount of eliminated targets, target accuracy (e.g., ratio of the amount of ammunition that hit a target to the amount of consumed ammunition), amount of eliminated civilians, time to eliminate a given amount of targets, amount of life left after facing a given amount of targets, etc.

In some instances, the server monitors, at a time point during the multiuser event, the APD score associated with the avatars participating in the multiuser event by assigning a respective weight to each IAPD score (mapped to the time point) of each avatar participating in the multiuser event, and performing the corresponding weighted sum. The IAPD scores of a subset of avatars participating in the multiuser event and the IAPD scores of another subset of the avatars participating in the multiuser event (wherein both subsets of avatars participating in the multiuser event are distinct from each other e.g., no avatar is shared by both subsets of avatars participating in the multiuser event) are of opposite signs.

In some approaches, the difference between the APD score associated with the avatars participating in the multiuser and the SPD score should, ideally, tend to zero. It is, however, difficult in practice to achieve a difference equal to zero since the APD score associated with the avatars participating in the multiuser event is based on the IAPD score of each single avatar participating in the multiuser event, in other words, on the performance of each avatar participating in the multiuser event which is difficult to predict. There is thus a need for an acceptable difference between the APD score associated with the avatars participating in the multiuser and the SPD score. Additionally, the occurrence frequency of the modulating, by the server, of the at least one subset of avatars participating in the multiuser event should be limited in order to maintain any subset of the avatars participating in the multiuser event (as long as possible) as it is. For instance, the departing of participating users (and thus of participating avatars) initiated by the sever should be avoided. Hence, the necessity to introduce a threshold.

In some approaches, the server selects the threshold among predefined multiuser event-dependent threshold values. In some approaches, the server determines a threshold value by selecting a figure ‘n’ between 0 and 1, and determining the product of ‘n’ by the absolute value of the SPD score mapped to the time point at which the server determines the APD score. At a given time point, the figure ‘n’, the SPD score and the APD score associated with the avatars participating in the multiuser event are linked by the following mathematical inequality:

$$n \geq \vert \frac{SPD score - APD score}{SPD score} \vert$$

$$Ratio A = \vert \frac{SPD score - APD score}{SPD score} \vert$$

In some instances, the server may set the figure ‘n’ to 0.1 implying that the difference between the APD score associated with the avatars participating in the multiuser event and the SPD score is not to exceed 10% of the SPD score. When the difference between the APD score associated with the avatars participating in the multiuser event and the SPD score exceeds 10% of the SPD score, the server modulates the at least one subset of avatars participating in the multiuser event by e.g., modifying the composition of the at least one subset of avatars participating in the multiuser event, the skill score of at least one avatar of the at least one subset of avatars participating in the multiuser event, or the participation level of at least one avatar of the at least one subset of avatars participating in the multiuser event. When the difference between the APD score associated with the avatars participating in the multiuser event and the SPD score does not exceed 10% of the SPD score, the server does not perform any corrective measures to reduce further the difference between the APD score associated with the avatars participating in the multiuser event and the SPD score.

In some instances wherein the server is more conservative, the server sets the figure ‘n’ to 0.05 implying that the difference between the APD score associated with the avatars participating in the multiuser event and the SPD score is not to exceed 5% of the SPD score. When the difference between the APD score associated with the avatars participating in the multiuser event and the SPD score exceeds 5% of the SPD score, the server modulates the at least one subset of avatars participating in the multiuser event by e.g., modifying the composition of the at least one subset of avatars participating in the multiuser event, the skill score of at least one avatar of the at least one subset of avatars participating in the multiuser event, or the participation level of at least one avatar of the at least one subset of avatars participating in the multiuser event. When the difference between the APD score associated with the avatars participating in the multiuser event and the SPD score does not exceed 5% of the SPD score, the server does not perform any corrective measures to reduce further the difference between the APD score associated with the avatars participating in the multiuser event and the SPD score.

In some instances wherein the server is more tolerant, the server sets the figure ‘n’ to 0.15 implying that the difference between the APD score associated with the avatars participating in the multiuser event and the SPD score is not to exceed 15% of the SPD score. When the difference between the APD score associated with the avatars participating in the multiuser event and the SPD score exceeds 15% of the SPD score, the server modulates the at least one subset of avatars participating in the multiuser event by e.g., modifying the composition of the at least one subset of avatars participating in the multiuser event, the skill score of at least one avatar of the at least one subset of avatars participating in the multiuser event, or the participation level of at least one avatar of the at least one subset of avatars participating in the multiuser event. When the difference between the APD score associated with the avatars participating in the multiuser event and the SPD score does not exceed 15% of the SPD score, the server does not perform any corrective measures to reduce further the difference between the APD score associated with the avatars participating in the multiuser event and the SPD score.

In some instances, wherein the server is strict, the server sets the figure ‘n’ to zero implying that the difference between the APD score associated with the avatars participating in the multiuser event and the SPD score is not to exceed 0% of the SPD score. When the difference between the APD score associated with the avatars participating in the multiuser event and the SPD score exceeds 0% of the SPD score, the server modulates the at least one subset of avatars participating in the multiuser event by e.g., modifying the composition of the at least one subset of avatars participating in the multiuser event, the skill score of at least one avatar of the at least one subset of avatars participating in the multiuser event, or the participation level of at least one avatar of the at least one subset of avatars participating in the multiuser event. In those instances, the probability for the server to continuously modulate at least one subset of avatars participating in the multiuser event is increased since there is no threshold. When the difference between the APD score associated with the avatars participating in the multiuser event and the SPD score is equal to 0% of the SPD score, the server does not perform any corrective measures to reduce further the difference between the APD score associated with the avatars participating in the multiuser event and the SPD score.

At a given time point, the threshold value, the figure ‘n’ and the SPD score are linked by the following mathematical equation:

$$threshold value = n \times \vert SPD score \vert$$

In some embodiments, the server sets multiple thresholds (e.g., a lower bound threshold, an upper bound threshold) to define ranges within which the server implements one or more specific types of corrective measures, by setting multiple values of the figure ‘n’ (e.g., ‘n₁’, ‘n₂’ such that 0<n₁<n₂<1): the higher the ‘n’ value, the more drastic the corrective measures the server is to implement. In some instances, when the Ratio A exceeds the lower bound threshold related to the ‘n₁’ value, the server modulates the at least one subset of avatars participating in the multiuser event by e.g., modifying the composition of the at least one subset of avatars participating in the multiuser event or the skill score of at least one avatar of the at least one subset of avatars participating in the multiuser event. In some instances, when the Ratio A exceeds the upper bound threshold related to the ‘n₂’ value, the server modulates the at least one subset of avatars participating in the multiuser event by e.g., modulating the participation level of at least one avatar of the at least one subset of avatars participating in the multiuser event. In some examples, the server extends the participation of the avatar(s) in question (belonging to the dominated subset of the avatars participating in the multiuser event) by extending the default set of actions available to the avatar(s). In some examples, the server restricts the participation of the avatar(s) in question belonging to the dominating subset of the avatars participating in the multiuser event) by restricting the default set of actions available to the avatar(s) in question.

In some embodiments, the server monitors the APD score associated with the avatars participating in the multiuser event by at least determining the APD score associated with the avatars participating in the multiuser event at a time point of the multiuser event. In some embodiments, the server bases the time point of the multiuser event on at least one avatar that stops participating in the multiuser event. In some embodiments, alternatively or additionally, the server bases the time point of the multiuser event on at least a change in the multiuser event. In some embodiments, alternatively or additionally, the server bases the time point of the multiuser event on a set time increment.

Hereby, the server determines the APD score associated with the avatars participating in a multiuser event at a time point during the multiuser event and not continuously during the multiuser event in order to save processing resources and energy to run them. In some approaches, the server determines the APD score associated with the avatars participating in a multiuser event at a series of time points equally distributed during the multiuser event e.g., by using a time increment from the start of the multiuser event to determine the series of equally distributed time points. In some approaches, the server determines the APD score associated with the avatars participating in a multiuser event at a series of time points unequally distributed during the multiuser event e.g., based on the detection, by the server, of events potentially inducing a change in the APD score associated with the avatars participating in the multiuser event (e.g., the departing of an avatar participating in the multiuser event due to the departing of a participating user, a change in the overall score of the multiuser event, a change in the number of fouls within a period, etc.). Those events potentially inducing a change in the APD score associated with the avatars participating in the multiuser event relate to the metrics used for determining the multiuser event dynamics. The metrics are multiuser event-dependent. If the multiuser event is a soccer video game, those events potentially inducing a change in the APD score associated with the avatars participating in the multiuser event can be e.g., as scored goals, goal attempts, ball ownership (e.g., time spent controlling the ball), field occupancy (e.g., time spent on the other team's side), successful passing rate (passing the ball between teammates), successful ball retrieving rate (stealing the ball from an opponent), amount and types of fouls, red card, yellow card, etc. In some approaches, the server determines the APD score associated with the avatars participating in a multiuser event at a series of time points unequally distributed during the multiuser event e.g., based on the detection, by the server, of a change in the multiuser event e.g., a change in the multiuser event outcome (such as the overall score, the number of fouls within a period, etc.), an interruption of the multiuser event due to network bandwidth issues. In some instances, the server determines the APD score associated with the avatars participating in a multiuser event at a series of time points during the multiuser event e.g., based on both a time increment and the detection, by the server, of events potentially inducing a change in the APD score associated with the avatars participating in the multiuser event (e.g., the departing of a user participating in the multiuser event that can imply the departing of the avatar controlled by the departing user, a change in the multiuser event outcome).

In some approaches, the server detects, during the multiuser event, an event potentially inducing a change in the APD score associated with the avatars participating in the multiuser event, then determines the APD score associated with the avatars participating in a multiuser event at a time point subsequent to the occurrence of the detection of the event. In this way, the time point, in question, is tied to an event potentially inducing a change in the APD score associated with the avatars participating in the multiuser event so as to minimize further the use of processing resources. In some instances, the event potentially inducing a change in the APD score associated with the avatars participating in the multiuser event (e.g., a participating user that stops participating in the multiuser event that can imply the departing of the avatar controlled by the departing user or a change in the multiuser event outcome). In some instances, the change in the multiuser event outcome is multiuser event-dependent. If the multiuser event is a match of soccer video game, the change in the multiuser event outcome can be e.g., a goal scored by an avatar controlled by a user participating in the soccer video game match, a red card received by an avatar controlled by a user participating in the soccer video game match, an injury of an avatar controlled by a user participating in the soccer video game match, the change of the avatar controlling the ball in the soccer video game. If the multiuser event is a shooter video game match, the change in the multiuser event outcome can be e.g., a target eliminated, the injuring or elimination of an avatar controlled by a user participating in the shooter game match.

In some embodiments, the server determines the APD score associated with the avatars participating in the multiuser event by at least summing, at the time point, individual actual performance dynamics (IAPD) scores, each IAPD score relating to an avatar participating in the multiuser event.

The IAPD score of an avatar controlled by a specific user represents the performance of the avatar (controlled by the specific user) during a multiuser event based on the actions performed by the avatar. The IAPD score of a participating avatar ‘z’ (being any avatar participating in the multiuser event) can be described by the following equation:

$${( IAPD score )}_{participating avatar z} = {\sum }_{i = 1}^{j} ( {a}_{i} * {x}_{i} ) - {\sum }_{l = 1}^{m} ( {b}_{l} * {y}_{l} )$$

where ‘aᵢ’, ‘bᵢ’, ‘xᵢ’ and ‘yₗ’ are a respective weight assigned to a value ‘xᵢ’ representing a beneficial action ‘i’, a respective weight assigned to a value ‘yₗ’ representing a detrimental action ‘l’, a value representing a beneficial action ‘i’ and a value representing a detrimental action ‘l’, respectively. Index ‘i’ corresponds to an integer between 1 and ‘j’. Index ‘l’ corresponds to an integer between 1 and ‘m’. And integers ‘l’ and ‘m’ are different from each other or the same. A beneficial action is an action performed by an avatar that promotes a multiuser event outcome favorable to the subset of the avatars participating in the multiuser event the avatar belongs to: a value ‘xᵢ’ is assigned to a beneficial action ‘i’ based on the type of the beneficial action ‘i’. A detrimental action is an action performed by an avatar that promotes a multiuser event outcome unfavorable to the subset of the avatars participating in the multiuser event the avatar belongs to: a value ‘yₗ’ is assigned to a detrimental action ‘l’ based on the type of the detrimental action ‘l’. The definition of a beneficial action and that of a detrimental action are multiuser event-dependent and depend upon the metrics taken into account to determine the multiuser event dynamics. The more beneficial to the multiuser event outcome (from the point of view of the subset of the avatars participating in the multiuser event, to which the avatar responsible for the beneficial action belongs) the beneficial action, the higher the value ‘xᵢ’ representing the beneficial action ‘i’. The more detrimental to the multiuser event outcome (from the point of view of the subset of the avatars participating in the multiuser event, to which the avatar responsible for the detrimental action belongs) the detrimental action, the higher the value ‘yₗ’ representing the detrimental action ‘l’. In some examples, the server determines the curve representing the IAPD score against the time of a multiuser event by detecting the occurrence of a beneficial action or a detrimental action at a time point, e.g., using a machine learning model controlling an image processing software able to analyze multiuser event images and categorize the actions of the avatars participating in the multiuser event. In some examples, the server determines the curve representing the IAPD score against the time of a multiuser event by detecting the occurrence of one or more beneficial actions and/or one or more detrimental actions during a time period defined between two consecutive time points, e.g., using a machine learning model controlling an image processing software able to analyze multiuser event images and categorize the actions of the avatars participating in the multiuser event. In some examples, the server identifies the nature of the multiuser event and accesses a list of multiuser event-dependent actions (e.g., beneficial actions, detrimental actions) that the avatars participating in the multiuser event could perform during a multiuser event. In some examples, the list of multiuser event-dependent actions contains the action values (e.g., values ‘xᵢ’ of beneficial actions, values ‘yₗ’ of detrimental actions) and weights (e.g., coefficient ‘aᵢ’, coefficient ‘bₗ’) assigned to the actions based on the type of the actions. In some examples, the server modifies the values of the weights (e.g., coefficient ‘aᵢ’, coefficient ‘bₗ’) assigned to the multiuser event-dependent actions in order to modulate the IAPD scores of at least one avatar participating in the multiuser event, and thus the APD score associated with the avatars participating in the multiuser event.

If the multiuser event is e.g., a match of a soccer video game, a beneficial action of an avatar may be e.g., a scored goal or goal attempt in the goal of the opposing team (e.g., another subset of the avatars participating in the multiuser event), owning the ball for a period of time, occupying the field of the opposing team for a period of time, successfully passing the ball to a teammate, stealing the ball from the opposing team. In some examples, scoring a goal in the goal of the opposing team is associated with the highest value for a beneficial action. If the multiuser event is e.g., a match of a soccer video game, a detrimental action of an avatar may be a foul performed, by the avatar, on another avatar from the opposing team or a referee, passing the ball to another avatar from the opposing team, losing the ball to another avatar from the opposing team, failing to steal the ball from an avatar from the opposing team e.g., located on the avatar's field. In some examples, depending on the gravity of the foul or the number of fouls already committed by the avatar, the avatar having performed the foul receives a red card leading to the departing of the avatar held responsible for the foul: receiving a red car is associated with the highest value for a detrimental action.

If the multiuser event is e.g., a shooter video game match, a beneficial action may be the elimination of a target in given circumstances (e.g., amount of ammunitions spent to eliminate the target, amount of collateral damage while eliminating the target, the time spent to eliminate the target). In some examples, the highest beneficial action value ‘xᵢ’ is associated with the elimination of a target with the smallest amount of ammunitions, collateral damages and time. In some examples, if the multiuser event is a shooter video game match involving a capture-the-flag aspect, the highest beneficial action value ‘xᵢ’ is associated with the capture of the flag of the opposing subset of avatars participating in the multiuser event, the capture of the flag being a beneficial action. If the multiuser event is e.g., a shooter video game match, a detrimental action may be the elimination of a teammate, the elimination of one or more individuals or specific items (collateral damage). In some examples, the highest detrimental action value ‘yₗ’ is associated with the elimination of a teammate. If the multiuser event is e.g., a shooter video game match involving a capture-the-flag aspect, the highest detrimental action value ‘yₗ’ is associated with the failure to prevent another avatar from an opposing subset of the avatars participating in the multiuser event from capturing the flag of the avatar of interest.

The server determines the APD score associated with the avatars participating in the multiuser event by e.g., summing, at a time point, IAPD scores (each IAPD score relating to an avatar participating in the multiuser event) or otherwise calculating by virtue of a function involving a single time point and IAPD scores (each IAPD score relating to an avatar participating in the multiuser event).

In some approaches, the APD score associated with the avatars participating in the multiuser event indicates which subset of avatars participating in the multiuser event dominates another subset of avatars participating in the multiuser event. The server determines the APD score associated with the avatars participating in the multiuser event by first summing, for each subset of the avatars participating in the multiuser event, the IAPD scores of the avatars of a subset of the avatars participating in the multiuser event, then by subtracting the summed IAPD scores of one subset from the summed IAPD score of the other subset. In other words, in some instances, at a time t, the APD score associated with the avatars participating in a multiuser event obeys the following equation:

$$APD score = {\sum }_{i = 1}^{j} {( IAPD score )}_{participating avatar i from subset 1} - {\sum }_{l = 1}^{m} {( IAPD score )}_{participating avatar l from subset 2}$$

wherein subset 1 and subset 2 comprise ‘j’ participating avatars and ‘m’ participating avatars, respectively. The letters ‘j’ and ‘m’ represent integers that can be different from or equal to each other. The index ‘i’ is an integer between 1 and the integer representing ‘j’. Similarly, the index ‘l’ is an integer between 1 and the integer representing ‘m’. Subset 1 and subset 2 are both subsets of avatars participating in the multiuser event, which are different from each other such that subset 1 and subset 2 do not share a same participating avatar.

In some approaches, the APD score associated with the avatars participating in the multiuser event indicates which subset of avatars participating in the multiuser event dominates another subset of avatars participating in the multiuser event. The server determines the APD score associated with the avatars participating in the multiuser event by first assigning, for each avatar of a subset of the avatars participating in the multiuser event, a respective weight to each IAPD score, then summing, for each subset of the avatars participating in the multiuser event, the weight-modified IAPD scores of the avatars of a subset of the avatars participating in the multiuser event (each IAPD score being modified by a respective weight), then by subtracting the summed weight-modified IAPD scores of one subset from the summed weight-modified IAPD score of the other subset. In other words, in some instances, at a time t, the APD score associated with the avatars participating in the multiuser event is a weighted sum of IAPD scores of the avatars participating in the multiuser event and obeys the following equation:

$$APD score = {\sum }_{i = 1}^{j} {( {k}_{i} * IAPD score )}_{participating avatar i from subset 1} - {\sum }_{l = 1}^{m} {( {p}_{l} * IAPD score )}_{participating avatar l from subset 2}$$

wherein subset 1 and subset 2 comprises ‘j’ participating avatars and ‘m’ participating avatars, respectively. The letters ‘j’ and ‘m’ represent integers that can be different from or equal to each other. The index ‘i’ is an integer between 1 and the integer representing ‘j’. Similarly, the index ‘l’ is an integer between 1 and the integer representing ‘m’. Subset 1 and subset 2 are both subsets of avatars participating in the multiuser event, which are different from each other such that subset 1 and subset 2 do not share a same participating avatar. The factor ‘kᵢ’ represents a respective weight assigned to the IAPD score of participating avatar ‘i’ belonging to subset 1. The factor ‘pᵢ’ represents a respective weight assigned to the IAPD score of participating avatar ‘l’ belonging to subset 2. The factor ‘kᵢ’ is an integer or a decimal and so is factor ‘pᵢ’.

In some approaches, a multiuser event (e.g., Battle Royale game) involves at least three distinct subsets of avatars participating in the multiuser event and all distinct subsets of avatars participating in the multiuser event (they do not share a single participating avatar) compete with each other. The server determines, at a time point, a respective APD score for each two distinct subsets of avatars participating in the multiuser event and compares it with a SPD score mapped to the time point. The SPD score is retrieved by the server from a selected predefined curve representing the SPD score against the time, defining the relationship (dominance or equality) between two respective subsets of avatars participating in the multiuser event. The predefined curve is selected by the server, prior to the start of the multiuser event, for describing a relationship of dominance or equality between two distinct subsets of avatars participating in the multiuser event. Accordingly, for each two distinct subsets of avatars participating in the multiuser event, the server selects a respective SPD score-related curve.

For instance, three teams A, B and C are competing against each other in a multiuser event. The server determines, at a time point, an APD score with respect to Team A and Team B and compares it with a SPD score (mapped to the time point) extracted from a curve representing the SPD score with respect to Team A and Team B against the multiuser event time. Additionally, the server determines, at a time point, an APD score with respect to Team B and Team C and compares it with a SPD score (mapped to the time point) extracted from a curve representing the SPD score with respect to Team B and Team C against the multiuser event time. Furthermore, the server determines, at a time point, an APD score with respect to Team C and Team A and compares it with a SPD score (mapped to the time point) extracted from a curve representing the SPD score with respect to Team C and Team A against the multiuser event time. The server selects respective SPD score-related curves such that there is a clear dominance order between Team A, Team B and Team C to avoid any inconsistencies. For instance, the server selects to have Team A dominate Team B and Team B dominate Team C. Automatically, the server is to deduce that Team C cannot dominate Team A.

In some embodiments, the server modulates the at least one subset of avatars participating in the multiuser event by at least selecting an avatar that is not currently participating in the multiuser event for inclusion into the at least one subset of avatars participating in the multiuser event. In some embodiments, additionally, the server selects the user that is not currently participating in the multiuser event based on an individual historical performance dynamics (IHPD) score of the avatar that is not currently participating in the multiuser event.

In this way, the server selects a possible new participating user e.g., from a lobby, a queue or a lobby/queue hybrid, to modify the APD score associated with the avatars participating in the multiuser event and cause a reduction in the difference between the APD score associated with the avatars participating in the multiuser event and the SPD score.

In some approaches, the server selects a possible new participating avatar e.g., from a waiting room (e.g., a lobby, a queue or a lobby/queue hybrid), to add the possible new participating avatar into the at least one subset of avatars participating in the multiuser event. Alternatively or additionally, the server selects a possible new avatar e.g., from a waiting room (e.g., a lobby, a queue or a lobby/queue hybrid), to replace an avatar from the at least one subset of avatars participating in the multiuser event. The server then determines, at a time point, the APD score associated with the avatars participating in the multiuser event, using the IHPD score of the possible new user as an IAPD score of the new possible participating avatar. In some instances, the server selects the possible new participating avatar from a waiting room (e.g., a lobby, a queue or a lobby/queue hybrid), such that the reduction in the difference between the APD score associated with the avatars participating in the multiuser event and the SPD score is below the threshold. Alternatively or additionally, the server selects the possible new participating avatar from a waiting room (e.g., a lobby, a queue or a lobby/queue hybrid), accounting for the highest reduction in the difference between the APD score associated with the avatars participating in the multiuser event and the SPD score. In some instances, the server treats both the lobby and the queue as lobby/queue hybrid from which the server selects the possible new participating avatar so as to include, without requesting a pause of the multiuser event while selecting the new participating avatar based on the characteristics of the new participating avatar (e.g., IHPD scores), the possible new participating avatar into the at least one subset of the users participating in the multiuser event.

In some embodiments, the server modulates the at least one subset of avatars participating in the multiuser event by at least selecting an avatar from the at least one subset of avatars based on an IAPD score of the selected avatar. In some embodiments, additionally, the server modulates the at least one subset of avatar participating in the multiuser event by at least modulating the participation of the selected avatar in the multiuser event. In some embodiments, alternatively, the server modulates the at least one subset of avatars participating in the multiuser event by at least modulating the IAPD score of the selected avatar.

The server can accordingly increase or decrease the APD score associated with the avatars participating in the multiuser event by selecting an avatar from one of the two opposing subsets and modulating the participation of the selected avatar. The APD score associated with the avatars participating in the multiuser event being equal to the subtraction of the sum of the IAPD scores of the second opposing subset from the sum of the IAPD scores of the first opposing subset, increasing the APD score implies extending the participation of an avatar selected from the first opposing subset or restricting the participation of an avatar selected from the second opposing subset; while decreasing the APD score associated with the avatars participating in the multiuser event involves restricting the participation of an avatar from the first opposing subset or extending the participation of an avatar selected from the second opposing subset.

In some approaches, the server restricts, for a duration, the default range of actions that the selected avatar can perform to a sub-range of actions, the default range of actions being the range of actions that an avatar can perform at any time during the multiuser event in absence of a restriction or an extension, implemented by the server, on the default range of actions. In some instances, the server restricts, for a duration, actions related to the mobility of the selected avatar: the server immobilizes, for a duration, the selected avatar at a fixed position within a virtual venue of the multiuser event (e.g., a jail-type venue or the virtual venue where the avatars participating in the multiuser event perform actions, e.g., soccer pitch when the multiuser event is a soccer video game match); or confines the selected avatar within a portion of the virtual venue (where the avatars participating in the multiuser event perform actions, e.g., soccer pitch when the multiuser event is a soccer video game match) while allowing the selected avatar to perform any actions of the default range other than the actions related to the mobility of the selected avatar. In some approaches, the server restricts, for a duration, actions involving an interaction between the selected avatar and an object (e.g., a ball, a puck, a racquet, a stick, skates, a weapon, ammunitions, etc.) that can effect directly or indirectly the outcome of the multiuser event (e.g., number of goals scored, number of kills). In some instances, the server prevents, for a duration, the selected avatar from interacting with the object. In some approaches, the server prevents the user controlling the avatar participating in the multiuser event from viewing the course of the multiuser event or entering inputs to give instructions to the avatar participating in the multiuser event.

In some approaches, the server extends, for a duration, the default range of actions that the selected avatar can perform to a supra-range of actions, the default range of actions being the range of actions that an avatar can perform at any time during the multiuser event in absence of a restriction or an extension, implemented by the server, on the default range of actions. In some instances, the server extends, for a duration, actions related to the mobility of the selected avatar: the server teleports the selected avatar (when requested by the user controlling the selected avatar) to a place of interest. In some approaches, the server extends, for a duration, actions involving an interaction between the selected avatar and an object (e.g., a ball, a puck, a racquet, a stick, skates, a weapon, ammunitions, etc.) that can effect directly or indirectly the outcome of the multiuser event (e.g., number of goals scored, number of kills). In some instances, the server imparts the selected avatar the power of attracting the object (when enabled by the user controlling the selected avatar) when the distance between the selected avatar and the object is below a threshold.

The server can consequently increase or decrease the APD score associated with the avatars participating in the multiuser event by selecting an avatar from one of the two opposing subsets and modifying the IAPD score of the selected avatar. The APD score associated with the avatars participating in the multiuser event being equal to the subtraction of the sum of the IAPD scores of the second opposing subset from the sum of the IAPD scores of the first opposing subset, increasing the APD score implies increasing the IAPD score of an avatar selected from the first opposing subset or decreasing the IAPD score of an avatar selected from the second opposing subset. Decreasing the APD score associated with the avatars participating in the multiuser event implies increasing the IAPD score of an avatar selected from the second opposing subset or decreasing the IAPD score of an avatar selected from the first opposing subset. The server increases or decreases the IAPD score of a selected avatar by increasing or decreasing an area of a geometric shape representing the skill score of the selected avatar in a spider diagram listing the skills (e.g., accuracy, speed, stamina, strength, stealth, dodging ability) of the selected avatar and the levels of skills of the selected user, respectively.

In some instances, when the multiuser event is a soccer video game match, increasing the accuracy and strength of a selected avatar participating in the soccer video game match allows for the increased control, by the selected avatar, of the ball when passed to one of their teammate, which improves the overall ball control of the subset of avatars participating in the soccer video game match to which the selected avatar belongs. This results in the increase of the APD score associated with the avatars participating in the multiuser event: the APD score reaches a higher ordinate value if the ordinate value is to be positive when the subset of the selected avatar dominates the other subset or a lower ordinate value if the ordinate value is to be negative when the subset of the selected avatar dominates the other subset.

In some embodiments, the server modulates the IAPD score of the selected avatar by at least determining a skill score contributing to the selected avatar's IAPD score. In some embodiments, additionally, the server modulates the IAPD score of the selected avatar by at least modifying the skill score of the selected avatar.

Hereby, the server increases or decreases the IAPD score of the selected avatar by increasing or decreasing the skill score of the selected avatar, respectively so as to increase or decrease the APD score associated with the avatars participating in the multiuser event depending on whether the selected avatar belongs to the first opposing subset or the second opposing subset.

In some embodiments, the server determines the APD score and the SPD score at a same time point of the multiuser event, between a start time point and an end time point of the multiuser event.

The server simultaneously determines the APD score and the SPD score at a time point, selected by the server, between the start time point and end time point of the multiuser event. In some examples, the server determines the APD score by summing the IAPD scores of each avatar participating in the multiuser event at the selected time point; while the server retrieves the SPD score mapped to the selected time point from the curve (that the server selected prior to the start of the multiuser event) representing the SPD score against the time of a multiuser event. In some examples, the server determines the APD score by summing the weight-modified IAPD scores of each avatar participating in the multiuser event at the selected time point; while the server retrieves the SPD score mapped to the selected time point from the curve (that the server selected prior to the start of the multiuser event) representing the SPD score against the time of a multiuser event.

In some embodiments, the server bases the SPD score on a SPD curve defined by a set of predefined SPD values as function of time points of the multiuser event.

Prior to the start of the multiuser event, the server selects a curve representing the SPD score against the time of a multiuser event among a set of predefined curves representing the SPD score against the time of a multiuser event. The server adjusts the selected SPD score-related curve based on the IHPD score-related curves of the avatars participating in the multiuser event.

In some embodiments, the server determines that the difference between the APD score associated with the avatars participating in the multiuser event and the SPD score is outside of the threshold by at least predicting a time point when at least one avatar of a subset of avatars participating in the multiuser event will stop participating in the multiuser event (when a user controlling the at least one avatar departs). In some embodiments, additionally, the server determines that the difference between the APD score associated with the avatars participating in the multiuser event and the SPD score is outside of the threshold by at least modulating the at least one subset of avatars participating in the multiuser event before the predicted time point.

In this way, the server is able to anticipate the departing of an avatar participating in the multiuser event and prepare in advance a solution to remedy the departing of the avatar participating in the multiuser event.

In some approaches, the server identifies an avatar participating in the multiuser event that will likely stop participating in the multiuser event and determines a time point (during the multiuser event) at which the avatar will likely stop participating in the multiuser event, based on e.g., historical metadata related to the users controlling the avatars participating in the multiuser event. In some instances, the historical metadata related to the users controlling the avatars participating in the multiuser event comprise historical metadata related to similar multiuser events (e.g., a series of soccer video game matches) or multiuser events of different types (e.g., a series of soccer video game matches and shooter video game matches). The server thus predicts the time point at which the user controlling the avatar participating in the multiuser event will likely stop participating in the multiuser event. The historical metadata related to a user controlling an avatar participating in the multiuser event comprises e.g., averaged duration of sessions during which a user controlling an avatar participating in the multiuser event attends at least one consecutive multiuser event; a tolerance score of the user (controlling the avatar participating in the multiuser event) to frustration induced by being easily dominated by the opposing subset they do not belong to; a tolerance score of the user (controlling the avatar participating in the multiuser event) to frustration induced by easily dominating the opposing subset they do not belong to. The server then establishes a list of ways involving a substitute avatar to modulate the two opposing subsets (one opposing subset at a time) to replace the likely departing avatar. The server then determines, for each way involving a substitute avatar, the APD score associated with the avatars participating in the multiuser event (consisting in the current participating avatars from which the likely departing avatar is removed and into which the substitute avatar is added) at a time point prior to the time point at which the avatar participating in the multiuser event stops participating in the multiuser event. The server subsequently orders or ranks the determined APD scores based on the difference between each determined APD score and the SPD score mapped to the same time point as each determined APD score. In some instances, the server selects the determined APD score corresponding to the lowest difference between the determined APD score and the SPD score. In some instances, the server selects a determined APD score such that the difference between the APD score and SPD score is below the threshold.

In some instances, as a respective user controls a respective avatar participating in the multiuser event, the IAPD score of the respective avatar participating in the multiuser event comprises at least one tolerance score of the respective user (controlling the respective avatar participating in the user event) to frustration e.g., induced by being easily dominated by or dominating the opposing subset they do not belong to. The higher the at least one tolerance score, the more likely the respective user controlling the respective avatar participating in the multiuser event is to maintain their participation in the multiuser event via the participation of the respective avatar participating in the multiuser event, the more performant the respective avatar participating in the multiuser event is. Additionally, the APD score associated with the avatars participating in the multiuser event and the SPD score would then be partly based on the at least one tolerance score of the respective user controlling the respective avatar participating in the multiuser event.

In some approaches, in the absence of a substitute avatar in the waiting room (e.g., a lobby, a queue or a lobby/queue hybrid), the server then establishes a list of ways to modulate the two opposing subsets (one opposing subset at a time) based on the avatars (other than the likely departing avatar) participating in the multiuser event. In some instances, the server favors, in priority, the ways involving the modulating of a skill score of at least one avatar (other than the likely departing avatar) participating in the multiuser event to offset the future absence of the likely departing avatar: the modulating of a skill score of an avatar participating in the multiuser event avoids the future removal of an avatar from the opposing subset to which the likely departing avatar does not belong. Additionally, this way contemplates the possibility to have opposing subsets of different number of avatars. The server then determines, for each way involving the modulating of a skill score of an avatar participating in the multiuser event, the APD score associated with the avatars participating in the multiuser event (consisting in the current participating avatars from which the likely departing avatar is removed) at a time point prior to the time point at which the avatar participating in the multiuser event stops participating in the multiuser event. The server subsequently orders or ranks the determined APD scores based on the difference between each determined APD score and the SPD score mapped to the same time point as each determined APD score. In some instances, the server selects the determined APD score corresponding to the lowest difference between the determined APD score and the SPD score. In some instances, the server selects a determined APD score such that the difference between the APD score and SPD score is below the threshold.

In some approaches, in the absence of a substitute avatar in the waiting room, (e.g., a lobby, a queue or a lobby/queue hybrid), the server then establishes a list of ways to modulate the two opposing subsets (one opposing subset at a time) based on the avatars (other than the likely departing avatar) participating in the multiuser event. In some instances, the server identifies at least one avatar participating in the multiuser event that will likely stop participating at a time point downstream of the time point at which the likely departing avatar stops participating in the multiuser event (and when the likely departing at least one avatar belong to an opposing subset different from the opposing subset of the likely departing avatar), the server favors, in priority, the ways involving the removal of an avatar (other than the likely departing avatar) participating in the multiuser event when the likely departing avatar stops participating in the multiuser event. The server then determines, for each way involving the removal of an avatar participating in the multiuser event, the APD score associated with the avatars participating in the multiuser event (consisting in the current participating avatars from which the likely departing avatar and the at least one departing avatar are removed) at a time point prior to the time point at which the avatar (the first one to likely depart) participating in the multiuser event stops participating in the multiuser event. The server subsequently orders or ranks the determined APD scores based on the difference between each determined APD score and the SPD score mapped to the same time point as each determined APD score. In some instances, the server selects the determined APD score corresponding to the lowest difference between the determined APD score and the SPD score. In some instances, the server selects a determined APD score such that the difference between the APD score and SPD score is below the threshold.

In some approaches, in the absence of a substitute user in the waiting room (e.g., a lobby, a queue or a lobby/queue hybrid), the server then establishes a list of ways to modulate the two opposing subsets (one opposing subset at a time) based on the likely departing avatar participating in the multiuser event. In some instances, the server generates an avatar of skills similar to those of the likely departing avatar participating in the multiuser event so as to replace the likely departing avatar participating in the multiuser event when departing. The server then controls the actions of the avatar of skills similar to those of the likely departing avatar participating in the multiuser event.

A multiuser event may comprise breaks allowing for the departing of an avatar participating in the multiuser event or the substitution of an avatar participating in the multiuser event by an avatar not currently participating in the multiuser event from a waiting room (e.g., a lobby, a queue or a lobby/queue hybrid).

In some embodiments, the server determines that the difference between the APD score associated with the avatars participating in the multiuser event and the SPD score is outside of the threshold by at least predicting a duration before an end of the multiuser event. In some embodiments, additionally, the server determines that the difference between the APD score associated with the avatars participating in the multiuser event and the SPD score is outside of the threshold by at least modulating the at least one subset of avatars participating in the multiuser event within the predicted duration.

Hereby, the server determines when the multiuser event ends in order to implement the modulating of the at least one subset of avatars participating in the multiuser event prior to the end of the multiuser event.

In some approaches, the at least one subset of avatars participating in the multiuser event comprises a first subset of avatars participating in the multiuser event and a second subset of avatars participating in the multiuser event, the first subset of avatars participating in the multiuser event being different from the second subset of avatars participating in the multiuser event (the first and second subsets do not share a single avatar). In some embodiments, the server modulates the at least one subset of avatars participating in the multiuser event by at least transferring an avatar from the first subset of avatars participating in the multiuser event to the second subset of avatars participating in the multiuser event.

In some embodiments, the APD score is based on individual actual performance dynamics (IAPD) scores associated with respective subsets of avatars participating in the multiuser event. Additionally, each IAPD score of an avatar is based at least on a beneficial action and/or a detrimental action performed by the avatar.

The server determines the APD score by identifying the avatars of the respective subsets (of the avatars participating in the multiuser event) of interest, determining the IAPD scores associated with said avatars and calculating, by virtue of a function involving a single time point and said IAPD scores, the APD score. In some examples, wherein all the avatars participating in the multiuser event are distributed at most between two respective subsets of avatars participating in the multiuser event (the two respective subsets do not share a single avatar), the APD score is associated with all the avatars participating in the multiuser event and the determination of the APD score involves the IAPD score of each avatar participating in the multiuser event. In some examples, wherein all the avatars participating in the multiuser event are distributed at least between three respective subsets of avatars participating in the multiuser event (each of the subsets do not share a single avatar with the other subsets), any APD score is associated with two respective subsets of avatars participating in the multiuser event and the determination of the APD score involves the IAPD score of the avatars belonging to the two respective subsets the avatars participating in the multiuser event. Accordingly, there is an APD score for each two respective subsets of avatars participating in the multiuser event.

In some embodiments, the SPD score is based on individual historical performance dynamics (IHPD) scores associated with respective subsets of avatars participating in the multiuser event.

In some examples, wherein all the avatars participating in the multiuser event are distributed at most between two respective subsets of avatars participating in the multiuser event (the two respective subsets do not share a single avatar), the SPD score is associated with all the avatars participating in the multiuser event and the determination of the SPD score involves the IHPD score of each avatar participating in the multiuser event. In some examples, wherein all the avatars participating in the multiuser event are distributed at least between three respective subsets of avatars participating in the multiuser event (each of the subsets do not share a single avatar with the other subsets), any SPD score is associated with two respective subsets of avatars participating in the multiuser event and the determination of the SPD score involves the IHPD score of the avatars belonging to the two respective subsets the avatars participating in the multiuser event. Accordingly, there is an SPD score for each two respective subsets of avatars participating in the multiuser event.

### BRIEF DESCRIPTION OF THE DRAWINGS

FIG. 1 illustrates an example for improving the engagement, with a multiuser event, of the users controlling each an avatar participating in the multiuser event, in accordance with some implementations of the disclosure;

FIG. 2 shows an example for improving the engagement, with a multiuser event, of the users controlling each an avatar participating in the multiuser event, in accordance with some implementations of the disclosure;

FIG. 3 represents an example for improving the engagement, with a multiuser event, of the users controlling each an avatar participating in the multiuser event, in accordance with some implementations of the disclosure;

FIG. 4 illustrates a flowchart describing an example for improving the engagement, with a multiuser event, of the users controlling each an avatar participating in the multiuser event, in accordance with some implementations of the disclosure;

FIG. 5 shows a flowchart describing an example for improving the engagement, with a multiuser event, of the users controlling each an avatar participating in the multiuser event, in accordance with some implementations of the disclosure;

FIG. 6 represents a flowchart describing an example for improving the engagement, with a multiuser event, of the users controlling each an avatar participating in the multiuser event, in accordance with some implementations of the disclosure;

FIG. 7 depicts a flowchart describing an example for improving the engagement, with a multiuser event, of the users controlling each an avatar participating in the multiuser even, in accordance with some implementations of the disclosure; and

FIG. 8 illustrates a block diagram showing components of an example system for improving the engagement, with a multiuser event, of the users controlling each an avatar participating in the multiuser event, in accordance with some implementations of the disclosure.

### DETAILED DESCRIPTION

As referred herein, the term ‘multiuser event’ should be understood to mean an online virtual multiuser event e.g., an online live video game, managed by a server, involving at least two opposing teams. In some instances, the server generates and controls one of the two opposing teams during the multiuser event. The multiuser event may be e.g., a sport-directed online live video match, a portion thereof, a shooter online live video game match, etc.

Each user participating in a multiuser event controls at least one avatar using a user device (e.g., a computer, a tablet, a mobile phone, a TV with a remote control, a TV with a console, etc.) comprising an input sub-device to instruct the avatar to perform multiuser event-dependent actions during the multiuser event and a display sub-device to present, in real time, the actions performed by the avatar to the user participating in the multiuser event. Each user device is in communication with a server (e.g., a local server or a remote server) hosting simultaneous online live multiuser events via a communication network (e.g., local network or remote network).

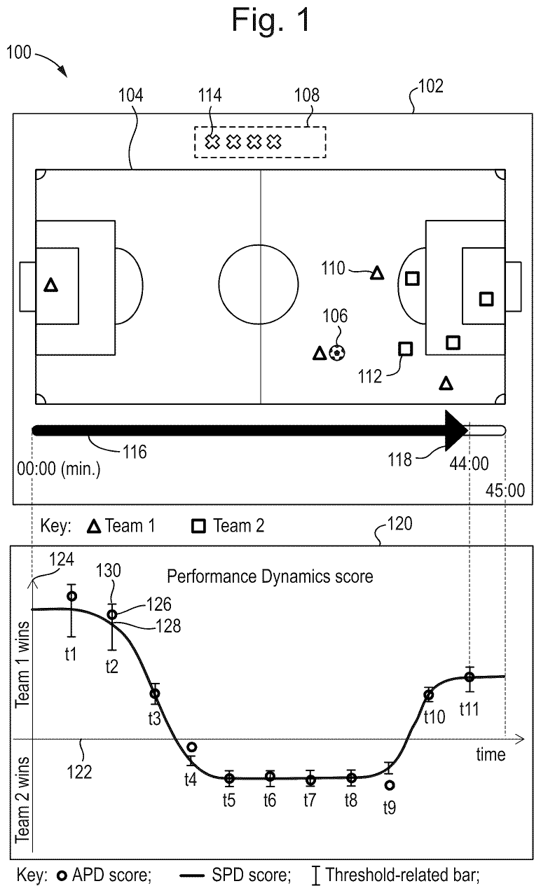

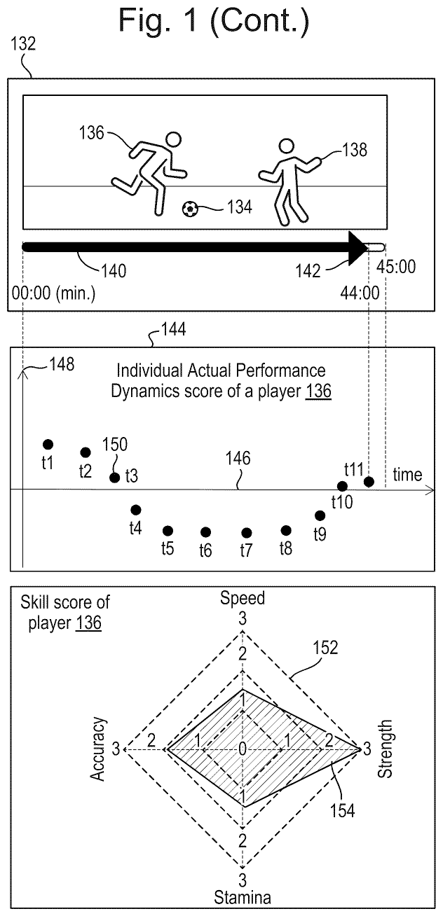

FIG. 1 illustrates an example 100 for improving the engagement, with a multiuser event, of the users controlling each an avatar participating in the multiuser event, in accordance with some implementations of the disclosure. The example 100 comprises a first screen 102 (representing an overview of the online live soccer match), a first graph 120 representing the performance dynamics score 124 of the players participating in the first period of the online live soccer match against the time 122 of the first period of the online live soccer match, a second screen 132 (representing a view of the online live soccer match focused on a single avatar e.g., player 136, that is presented to a user controlling player 136), a second graph 144 representing the IAPD score 148 of a player of Team 1 (e.g., player 136) against the time 146 of the first period of the online live soccer match, and a spider diagram 152 representing a skills score 154 of the very same player of Team 1.

The server presents, to all users participating in the first soccer match period, first screen 102 depicting a soccer field 104, two opposing teams (See, for the sake of clarity, triangle-shaped player 110 as a representative of Team 1 and square-shaped player 112 as a representative of Team 2), a soccer ball 106, a lobby/queue hybrid 108, a progress bar 116 and a progress indicator 118.

Prior to the start of the first soccer match period, the server selects, from a plurality of players, e.g., four players for Team 1 (See e.g., triangle-shaped player 110) and e.g., four players for Team 2 (See e.g., square-shaped player 112) of Team 2, based on curves representing the IHPD score of each selected player against the time of a first period of a past soccer match. As mentioned earlier, the server distributes the participating players between Team 1 and Team 2 based on the latest experiences (e.g., number of consecutive unfavorable and/or favorable outcomes) of the users controlling the participating players so as to offset the latest experiences of a maximum number of participating users at least for a given period of time (within the duration of the multiuser event). The server then selects, from a series of predefined curves representing a SPD score of eight players participating in a first period of an online live soccer match, a curve of the series e.g., which requires fewer adjustments based on the IHPD score-related curves of the selected players and that allows for offsetting the latest experiences of a maximum number of participating users at least for a given period of time (within the duration of the multiuser event). The server subsequently adjusts the predefined SPD score-related curve. Depending on the availability of players, lobby/queue hybrid 108 comprises none or at least one player 114 that is not currently participating in the online live soccer match but could join one of the teams at a given time.

The scene of the soccer match depicted in screen 102 corresponds to the start of the 45^{th} minute of the first soccer match period as indicated by progress indicator 118 of progress bar 116. The first soccer match period ends at the 45 minutes mark of progress bar 116. At time point t11 corresponding to the start of the 45th minute of the first soccer match period as indicated by progress indicator 118, three triangle-shaped players (Team 1) are located in Team 2's portion of the soccer field and one of the three triangle-shaped players (Team 1) possesses soccer ball 106, whereas the four square-shaped players (Team 2) are defending the goal of Team 2. There is a time correspondence between progress bar 116 and time axis 122 of first graph 120 (See dashed lines linking first screen 102 and first graph 120).

During the first period of the online live soccer match, the server determines, at every time point (e.g., one of t1 to t11—two consecutive time points are spaced e.g., four minutes apart), the APD score associated with the eight players participating in the first soccer match period, then the difference between the APD score and the corresponding SPD score retrieved from the adjusted predefined SPD score-related curve (the predefined SPD score-related curve was selected earlier by the server). In first graph 120, the server plots both the SPD score-related curve and the APD score-related points (whose coordinates are a given time point e.g., one of t1 to t11 and an APD score determined at the corresponding time point) in a coordinate system using time axis 122 and performance dynamics score axis 124. The server subsequently compares the difference between the APD score and the SPD score with the threshold-related bar whose size is equal to twice the threshold value (which is, in turn, equal to the product of figure ‘n’ by the corresponding SPD score and the figure ‘n’ is set to 0.1). The threshold-related bar is positioned, vertically at every time point, such that the middle of the threshold-related bar is positioned on the SPD score-related curve. For the sake of clarity, the depicted size of each threshold-related bar is not at scale with the corresponding SPD score.

For instance, at time point t2, the server determines an APD score 126 associated with the eight players participating in the first period of the online live soccer match, then the difference between APD score 126 and a corresponding SPD score 128. Subsequently, the server compares this difference with half of a threshold-related bar 130. For the sake of clarity, the other APD scores, the other SPD scores and the other threshold-related bars do not have numberings.

From time point t1 to time point t3, Team 1 dominates Team 2. From time point t4 to time point t9, Team 2 dominates Team 1. From time point t10 to time point t11, Team 1 dominates Team 2. At time points t4 and t9, the corresponding APD score associated with the eight players participating in the online live soccer match are located outside of the threshold-related bar, compelling the server to modulate the composition of Team 1 (or Team 2) or to modify the skills score of at least one player of Team 1 (or Team 2) or to modify the level of participation of at least one player of Team 1 (or Team 2). The last two options present the advantage to maintain the former composition of Team 1 (or Team 2). The addition of new player into Team 2 (or Team 1) negates the need to remove a player from Team 1 (or Team 2), which likely would frustrate less users than if a new player were to replace a player of Team 1 (or Team 2) participating in the online live soccer match (which would imply the departing of a player and thus the departing of a user).

The server presents, to the user controlling player 136 of Team 1 at time point t11 corresponding to the start of the 45^{th} minute of the first soccer match period as indicated by progress indicator 142 of progress bar 140, second screen 132 depicting player 136 of Team 1 possessing the soccer ball 134 and attempting to pass over player 138 of Team 2. The first soccer match period ends at the 45 minutes mark of progress bar 140. There is a time correspondence between progress bar 140 and time axis 146 of second graph 144 (See dashed lines linking second screen 132 and second graph 144). There is also a time correspondence between first screen 102, first graph 120, second screen 132 and second graph 144.

During the first soccer match period, the server determines, at every time point (e.g., one of t1 to t11), the APD score associated with the eight players participating in the online live soccer match by subtracting the sum of the IAPD scores of the four players of Team 2 from the sum of the IAPD scores of the four players of Team 1. At every time point, the server determines the IAPD score of each player based on an algorithm (See above the paragraphs related to IAPD scores) that takes into account e.g., scored goals, goal attempts, ball ownership (e.g., time spent controlling the ball), field occupancy (e.g., time spent on the other team's side), successful passing rate (passing the ball between teammates), successful ball retrieving rate (stealing the ball from an opponent), amount and types of fouls, red card, yellow card, etc. In second graph 144 based on a coordinate system using time axis 146 and Individual Actual Performance Dynamics (IAPD) score axis 148, the server plots a series of points (e.g., point 150) whose coordinates are a given time point (e.g., one of t1 to t11) and an IAPD score of player 136 determined at the corresponding time point.

Additionally, the server plots the spider diagram 152 based on e.g., four skills (such as speed, accuracy, stamina and strength) of player 136, wherein each skill value is between a minimum value (e.g., 0) and a maximum value (e.g., 3). The server joins the four points, each point corresponding to a value of a skill (and thus becoming a vertex of a quadrilateral 154) so as to form a quadrilateral 154. The server determines the area of quadrilateral 154 so as to determine a skill score. In some approaches, the server plots a spider diagram based on more than four skills and joins the points, each point corresponding to a value of a skill, so as to form a geometrical shape, and determines the area of the geometric shape to determine the skill score of a player. During the first period of the soccer match, the server is able to modify the skill score of a player to tune the IAPD score of the same player in order to modulate Team 1 when the difference between the APD score associated with the eight players participating in the online live soccer match and the SPD score is above a threshold.

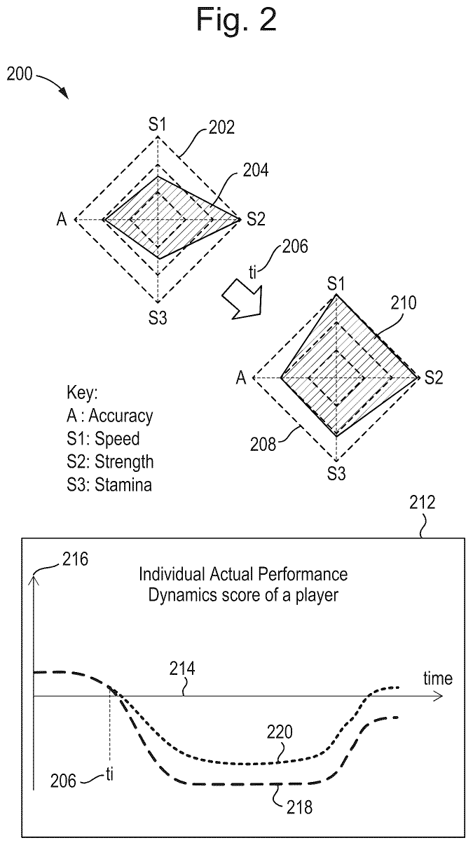

FIG. 2 depicts an example 200 for improving the engagement, with a multiuser event, of users controlling each an avatar participating in the multiuser event, in accordance with some implementations of the disclosure. Example 200 comprises a first spider diagram 202 related to a player of Team 1 (or Team 2), a second spider diagram 208 related to the same player and a graph 212 representing a series of points whose coordinates are a given time point (not shown) and an IAPD score of the same player determined at the corresponding time point.

First spider diagram 202 and second spider diagram 208 depict a first quadrilateral 204 and second quadrilateral 210, respectively: the area of second quadrilateral 210 is greater than the area of the first quadrilateral 204. At a time point ‘tᵢ’ during the online live soccer match, the server increases the value of the speed of the player and the value of the stamina of the player while maintaining the value of the accuracy of the player and the value of the strength of the player such that first quadrilateral 204 turns into second quadrilateral 210.

Graph 212 shows, in a coordinate system using time axis 214 and individual actual performance dynamics (IAPD) score axis 216, a first curve 218 representing the IAPD score of player 136 against the time of the first period of the soccer match when the skill score of the player is represented by the area of first quadrilateral 204 throughout the online live soccer match, and a second curve 220 (starting at time point ‘tᵢ’ indicated by numbering 206) representing the IAPD score of the player against the time of the first period of the soccer match when the skill score of the player is represented by the area of second quadrilateral 210 throughout the rest of the duration of the online live soccer match. By increasing the skill score of player 136, the server promotes the increase of performance of player 136: second curve 220 is located above first curve 218. The server is able to tune the IAPD score of a player to modify the APD score associated with the players participating in the online live soccer match when the difference between the APD score and SPD score is outside of a threshold in order to reduce said difference.

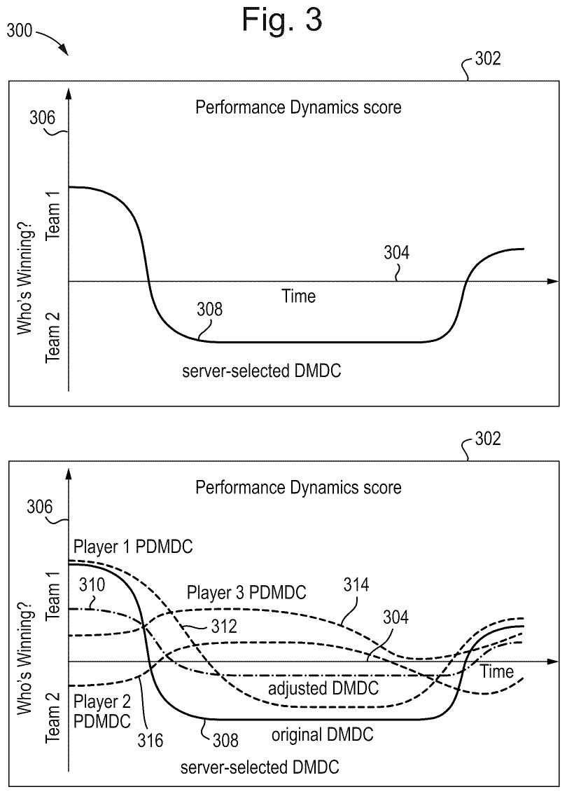

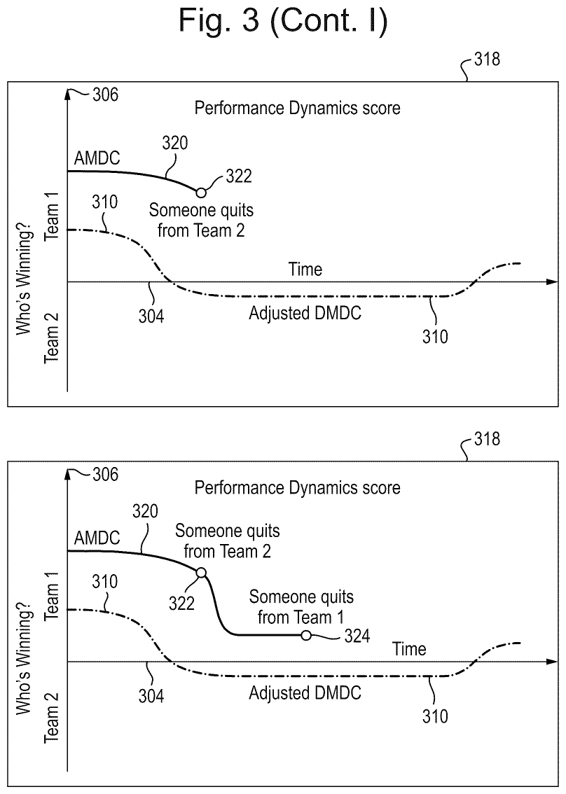

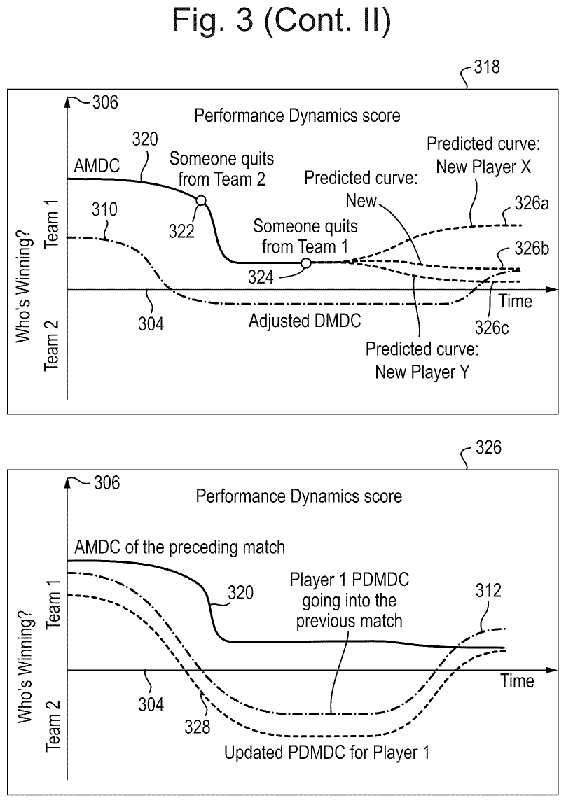

FIG. 3 represents an example 300 for improving the engagement, with a multiuser event, of the users controlling each an avatar participating in the multiuser event in accordance with some implementations of the disclosure.

A person desires to play a few online live multiplayer soccer matches on a soccer video game and joins a lobby/queue hybrid so as to participate in a newly-generated online live soccer match. The server hosting the multiplayer soccer matches identifies the metrics to be used for determining the soccer match dynamics such as scored goals, goal attempts, ball ownership (e.g., time spent controlling the ball), field occupancy e.g., time spent on the other team's side, successful passing rate (passing the ball between teammates), successful ball retrieving rate (stealing the ball from an opponent), amount and types of fouls, red card, yellow card, etc. The server then selects a predefined curve 308 called desired match dynamics curve (DMDC) representing the desired match dynamics (DMD) score against the time 304 of a first period of a soccer match (from a series of predefined curves representing the DMD score against the time of a first period of a soccer match) as the guide for AMDC during the upcoming first soccer match period. The term ‘DMD score’ is an example of ‘SPD score’. Similarly, the term ‘DMDC’ is an example of a curve representing the SPD score against the time of a multiuser event. The ordinate axis 306 represents any performance dynamics score e.g., DMD score, actual match dynamics (AMD) score and personalized desired match dynamics (PDMD) score. The term ‘AMD score’ is an example of ‘APD score’. The term ‘PDMD score’ is an example of IHPD score. There is a curve, called DMDC (the last letter stands for the word ‘curve’), representing the DMD score against the time of a soccer match. There is a curve, called AMDC (the last letter stands for the word ‘curve’), representing the AMD score against the time of the online live soccer match. There is a curve, called PDMDC (the last letter stands for the word ‘curve’), representing the PDMD score against the time of a past soccer match.

The server analyzes historical metadata of the avatars (e.g., players) when controlled by specific users, that are going to participate in the first period of the soccer match so as to determine the average length of the play session during which the users attend at least a portion of a soccer match, the average soccer match length the users play, the predicted number of soccer matches the users play as well as the type (e.g., favorable or unfavorable) and number of outcomes of past soccer matches they recently played. The server distributes the avatars participating in the first soccer match period between Team 1 and Team 2, based on e.g., the type of outcomes of the past soccer matches the users (controlling the avatars participating in the first soccer match period) recently experienced. For instance, multiple users controlling the avatars participating in the first soccer match period on Team 1 have had some rough losses recently and the server assigns the positive ordinates of graph 302 as reflecting the dominance of Team 1 over Team 2 and the negative ordinates of graph 302 as reflecting the dominance of Team 2 over Team 1. Accordingly, any portions of a curve (e.g., the DMD score-related curve 308 or the adjusted DMD score-related curve 310 or the AMD score-related curve 320) located in the positive ordinate indicate the dominance of Team 1 over Team 2 and any portions of a curve (e.g., the DMD score-related curve 308 or 310 or the AMD score-related curve 320) located in the negative ordinate indicate the dominance of Team 2 over Team 1. The server places high-skilled players on Team 1 to offset the fact that multiple users (controlling avatars participating in the first soccer match period) on Team 1 have had some rough losses recently. The server also places lower-skilled users (controlling avatars participating in the first soccer match period) on Team 2. (For example, if every Team 2 avatars had just barely won their previous game, the DMD score-related curve would favor that team more than if every Team 2 avatars had dominated the past several matches.)

After having formed Team 1 and Team 2, the server retrieves, from the historical metadata, the averaged PDMD score-related curves for each avatar participating in the first soccer match period when controlled by a respective user. The server then adjusts the selected DMD score-related curve based on the averaged PDMD score-related curve (e.g., averaged PDMD score-related curve 312 of Avatar 1 when controlled by a respective user, averaged PDMD score-related curve 314 of Avatar 3 and averaged PDMD score-related curve 316 of Avatar 2) of each avatar participating in the first soccer match period.

As the first soccer match period starts, the server determines, at every time point, the AMD score associated with the avatars participating in the first soccer match period so as to plot the AMD score-related curve. The server determines the amount of time points (during the first soccer match period) at which the server determines the AMD score associated with the avatars participating in the first soccer match period as well as the time interval between two consecutive time points and whether the time interval is fixed or evolving during the first soccer match period. For instance, the server sets that the series of time points is equally spaced in time from the start time point to the end time point of the first soccer match period. For instance, the fixed time interval between two consecutive time points is e.g., between 5 and 10 seconds. Afterwards, the server plots, in graph 318, the curve 320 representing the AMD score associated with the avatars participating in the first soccer match period against the time of the first soccer match period, e.g. the points whose abscissas and ordinates are AMD scores associated with the avatars participating in the first soccer match period and time points, respectively.

The server then determines, at every time point, the difference between the AMD score associated with the avatars participating in the first soccer match period and the DMD score, and compares to a threshold value equal to the product of the DMD score by the figure ‘n’, the figure ‘n’ being equal to 0.1. For the sake of clarity, the threshold-related bars are not indicated on graph 318.

Team 1 is unexpectedly so dominant at the start of the first soccer match period, that the AMD score associated with the avatars participating in the first soccer match period is much higher than the SPD score, exceeding the threshold. The server modulates Team 1 by decreasing the skill score of all avatars of Team 1. Following the high dominance of Team 1 over Team 2, the server anticipates the departure of a specific avatar of Team 2 based on the low tolerance to the high dominance of an opposing team, of the user controlling the specific avatar. The server selects, in anticipation, a highly skilled avatar from the lobby/queue hybrid based on the PDMD score to replace the specific avatar of Team 2. At the time point corresponding to point 322, the specific avatar on Team 2 leaves the soccer match and the server immediately counter-reacts by turning the highly-skilled substitute avatar into a new participating avatar for Team 2.

The arrival of highly-skilled substitute avatar into Team 2 triggers a better performance from Team 2, resulting in a substantial decrease of the AMD score associated with the avatars participating in the first soccer match period. Then, the server anticipates the departing of a specific avatar from Team 1, the specific avatar being controlled by a user that does not tolerate well the lack of challenge. The server, in anticipation, selects a substitute avatar with an PDMD score that could reduce further the difference between the AMD score associated with the avatars participating in the first soccer match period and the adjusted DMD score-related curve 310: the curve portions 326a, 326b and 326c illustrate what the AMD score associated with the avatars participating in the first soccer match period could be using the PDMD score of different avatars from the lobby/queue hybrid. At the time point corresponding to point 324 of graph 318, an avatar from Team 1 leaves the soccer match.

At the end of the first soccer match period, the server finishes plotting, on graph 326, the curve 320 representing the AMD score associated with the avatars participating in the online live soccer match against the time 304 of the first soccer match period. The server records the curves (e.g., curve 328) representing the personalized actual match dynamics (PAMD) scores (which are examples of IAPD scores) of the avatars having participated in the first soccer match period against the time of the first soccer match period, which becomes PDMD scores of the avatars having participated in the first soccer match period. The PDMD score of Avatar 1 has, in effect, evolved: See the difference between the PDMD score-related curve 328 as the first soccer match period ended and the former PDMD score-related curve 312 on graph 326.

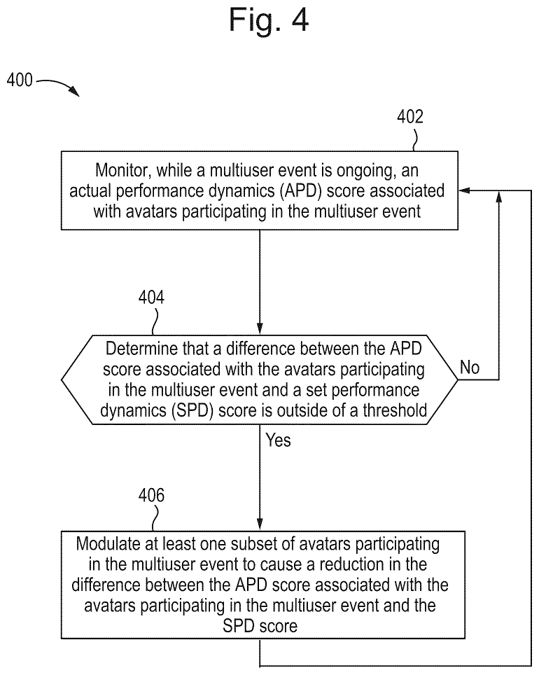

FIG. 4 illustrates a flowchart describing an example 400 for improving the engagement, with a multiuser event, of users controlling each an avatar participating in the multiuser event, in accordance with some implementations of the disclosure.

In some embodiments, prior to the start of the multiuser event (e.g., a soccer match depicted e.g., in first screen 102 or in second screen 132), control circuitry of the server (e.g., server 804) selects a predefined curve representing a set performance dynamics (SPD) score associated with the participating avatars against the time of the multiuser event (from a series of predefined curves representing the SPD score associated with the participating avatars against the time of a multiuser event). For the sake of clarity, the SPD score associated with the avatars participating in the multiuser event is called hereinafter the SPD score. In some embodiments, prior to the start of the multiuser event (e.g., a soccer match depicted e.g., in first screen 102), the control circuitry of the server selects avatars from a lobby/queue hybrid (e.g., lobby/queue hybrid 108) that are to become avatars participating in the multiuser event and forms at least one subset of avatars participating in the multiuser event. A subset of avatars participating in the multiuser event is a team e.g., Team 1 represented by triangle-shaped players (e.g., player 110) or Team 2 represented by square-shaped players (e.g., player 112).

In some approaches, when there is an insufficient number of avatars in the lobby/queue hybrid (compared to the number of avatars requested by the multiuser event), the control circuitry of the server forms only a single subset of avatars participating in the multiuser event based on the avatars from the lobby/queue hybrid. Any avatar of the single subset of avatars participating in the multiuser event is controlled by a user using a user device connected to the server via a communication network (e.g., local network or remote network). The control circuitry of the server then generates another subset of avatars participating in the multiuser event and controls the performance of the other subset of avatars participating in the multiuser event. In some instances, in order to offset the insufficient number of avatars in the lobby/queue hybrid, a non-transitory computer-readable medium comprises instructions that when executed by the control circuitry of the server causes the control circuitry of the server to generate at least one avatar participating in the multiuser event and the curve representing the IHPD score of the at least one avatar participating in the multiuser event against the time of a multiuser event and to control the performance of the at least one avatar participating in the multiuser event during the multiuser event. Irrespective of whom (e.g., several users or the server) controls a subset, both subsets compete against each other.

In some approaches, when there is a sufficient number of avatars in the lobby/queue hybrid, the control circuitry of the server forms two subsets of avatars participating in the multiuser event based on the avatars from the lobby/queue hybrid, each being controlled by a single user: each avatar is controlled by a user using a user device connected to the server via a communication network (e.g., local network or remote network) and both subsets of avatars participating in the multiuser event compete against each other. The two subsets are different from each other and do not share a single avatar.

In some approaches, when there is an insufficient number of avatars in the lobby/queue hybrid (compared to the number of avatars requested by the multiuser event), the control circuitry of the server forms two subsets of avatars participating in the multiuser event which both comprise avatars from the lobby/queue hybrid and avatars, generated by the control circuitry of the server, whose performance during the multiuser event is controlled by the server. In some approaches, the control circuitry of the server adjusts the selected SPD score-related curve based on the IHPD scores of the avatars of the at least one subset of users participating in the multiuser event. The two subsets are different from each other and do not share a single avatar.

In some embodiments, at step 402, the control circuitry of the server monitors, while a multiuser event is ongoing, an actual performance dynamics (APD) score associated with avatars participating in the multiuser event. The term ‘monitor, while a multiuser event is ongoing, an APD score associated with avatars participating in the multiuser event’ should be understood to mean to determine, at at least one time point during the multiuser event, the APD score associated with avatars participating in the multiuser event.

In some embodiments, at step 404, the control circuitry of the server determines that a difference between the APD score associated with the avatars participating in the multiuser event and a set performance dynamics (SPD) score is outside of a threshold. In some embodiments, at step 404, the control circuitry of the server determines that a difference between the APD score associated with the avatars participating in the multiuser event and a set performance dynamics (SPD) score is outside of a threshold by determining the APD score associated with the avatars participating in the multiuser event and the SPD score at a same time point. In some approaches, at step 404, the control circuitry of the server sets the threshold as being a product of a figure ‘n’ by the SPD score by setting the figure ‘n’ to a value between 0 and 1 while the control circuitry of the server retrieves the SPD score from the selected predefined SPD score-related curve. If the difference between the APD score associated with the avatars participating in the multiuser event and the SPD score is outside of the threshold, the control circuitry of the server proceeds to step 406. If the difference between the APD score associated with the avatars participating in the multiuser event and the SPD score is not outside of the threshold, the control circuitry of the server proceeds back to step 402.

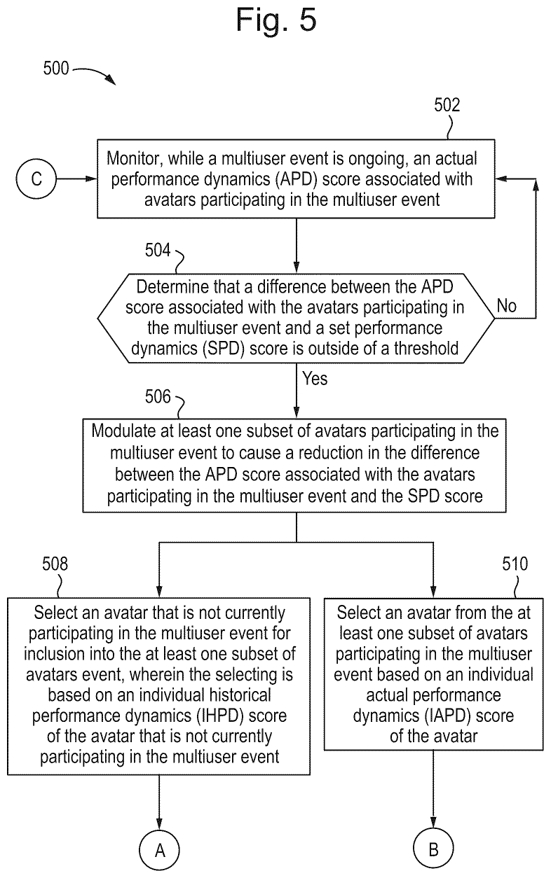

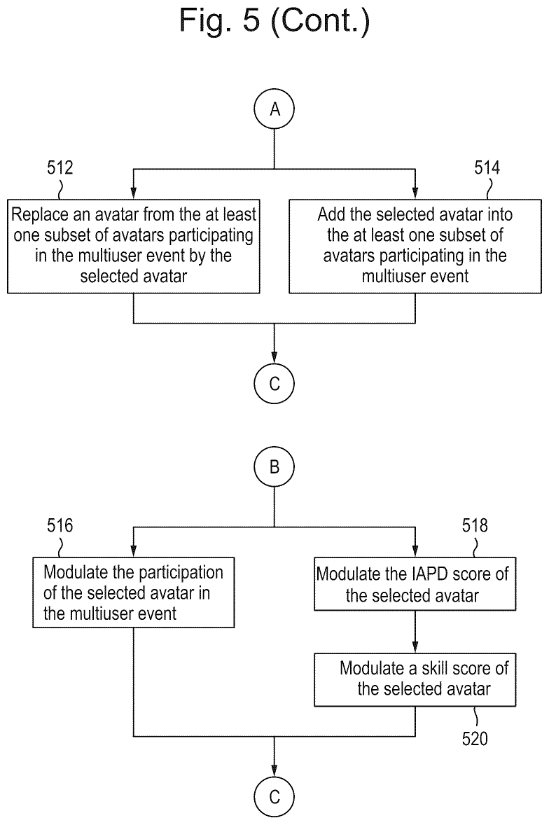

In some embodiments, at step 406, the control circuitry of the server modulates at least one subset of avatars participating in the multiuser event to cause a reduction in the difference between the APD score associated with the avatars participating in the multiuser event and the SPD score. In some embodiments, at step 406, the control circuitry of the server modulates at least one subset of avatars participating in the multiuser event to cause a reduction in the difference between the APD score associated with the avatars participating in the multiuser event and the SPD score, by performing any one of steps 512, 514, 516 and 520 (depicted in FIG. 5). In some embodiments, at step 406, the control circuitry of the server modulates, prior to the occurrence of the predicted time point, at least one subset of avatars participating in the multiuser event to cause a reduction in the difference between the APD score associated with the avatars participating in the multiuser event and the SPD score, by simulating any one of steps 512, 514, 516 and 520 (depicted in FIG. 5), selecting any one of steps 512, 514, 516 and 520 (depicted in FIG. 5) to have the highest reduction and implementing the selected step. Alternatively, at step 406, the control circuitry of the server modulates, prior to the occurrence of the predicted time point, at least one subset of avatars participating in the multiuser event to cause a reduction in the difference between the APD score associated with the avatars participating in the multiuser event and the SPD score, by simulating any one of steps 512, 514, 516 and 520 (depicted in FIG. 5), selecting any one of steps 512, 514, 516 and 520 (depicted in FIG. 5) to have the lowest reduction allowing the difference to be below the threshold and implementing the selected step. In some approaches, at step 406, the control circuitry proceeds back to step 402.

FIG. 5 shows a flowchart describing an example 500 for improving the engagement, with a multiuser event, of the users controlling each an avatar participating in the multiuser event, in accordance with some implementations of the disclosure.

In some embodiments, prior to the start of the multiuser event (e.g., a soccer match depicted e.g., in the first screen 102 or in second screen 132), control circuitry of the server (e.g., server 804) selects a predefined curve representing a set performance dynamics (SPD) score associated with the participating avatars against the time of the multiuser event (from a series of predefined curves representing the SPD score associated with the participating avatars against the time of a multiuser event). For the sake of clarity, the SPD score associated with the avatars participating in the multiuser event is called hereinafter the SPD score. In some embodiments, prior to the start of the multiuser event (e.g., a soccer match depicted e.g., in first screen 102), the control circuitry of the server selects avatars from a lobby/queue hybrid (e.g., lobby/queue hybrid 108) that are to become participating avatars during the multiuser event and forms at least one subset of avatars participating in the multiuser event. A subset of avatars participating in the multiuser event is a team e.g., Team 1 represented by triangle-shaped players (e.g., player 110) or Team 2 represented by square-shaped players (e.g., player 112). The control circuitry of the server then generates another subset of avatars participating in the multiuser event and controls the performance of the other subset of avatars participating in the multiuser event. In some approaches, when there is an insufficient number of avatars in the lobby/queue hybrid (compared to the number of avatars requested by the multiuser event), the control circuitry of the server forms only a single subset of avatars participating in the multiuser event based on the users from the lobby/queue hybrid. Any avatar of the single subset of avatars participating in the multiuser event is controlled by a user using a user device connected to the server via a communication network (e.g., local network or remote network). In some instances, in order to offset the insufficient number of avatars in the lobby/queue hybrid, a non-transitory computer-readable medium comprises instructions that when executed by the control circuitry of the server causes the control circuitry of the server to generate at least one avatar participating in the multiuser event and the curve representing the IHPD score of the at least one avatar participating in the multiuser event against the time of a multiuser event and to control the performance of the at least one avatar participating in the multiuser event during the multiuser event. Irrespective of whom (e.g., several users or the server) controls a subset, both subsets compete against each other.

In some approaches, when there is a sufficient number of avatars in the lobby/queue hybrid, the control circuitry of the server forms two subsets of avatars participating in the multiuser event based on the avatars from the lobby/queue hybrid: each avatar is controlled by a user using a user device connected to the server via a communication network (e.g., local network or remote network) and both subsets of avatars participating in the multiuser event compete against each other. The two subsets are different from each other and do not share a single avatar.

In some approaches, when there is an insufficient number of avatars in the lobby/queue hybrid (compared to the number of avatars requested by the multiuser event), the control circuitry of the server forms two subsets of avatars participating in the multiuser event which both comprise avatars from the lobby/queue hybrid and avatars, generated by the control circuitry of the server, whose performance during the multiuser event is controlled by the server. In some approaches, the control circuitry of the server adjusts the selected SPD score-related curve based on the IHPD scores of the avatars of the at least one subset of avatars participating in the multiuser event. The two subsets are different from each other and do not share a single avatar.

In some embodiments, at step 502, control circuitry of the server monitors, while a multiuser event is ongoing, an actual performance dynamics (APD) score associated with avatars participating in the multiuser event. The term ‘monitor, while a multiuser event is ongoing, an APD score associated with avatars participating in the multiuser event’ should be understood to mean to determine, at at least one time point during the multiuser event, the APD score associated with avatars participating in the multiuser event.

In some embodiments, at step 504, the control circuitry of the server determines that a difference between the APD score associated with the avatars participating in the multiuser event and a set performance dynamics (SPD) score is outside of a threshold. In some embodiments, at step 504, the control circuitry of the server determines that a difference between the APD score associated with the avatars participating in the multiuser event and a set performance dynamics (SPD) score is outside of a threshold by determining the APD score associated with the avatars participating in the multiuser event and the SPD score at a same time point. In some approaches, at step 504, the control circuitry of the server sets the threshold as being a product of a figure ‘n’ by the SPD score by setting the figure ‘n’ to a value between 0 and 1 while the control circuitry of the server retrieves the SPD score from the selected predefined SPD score-related curve. If the difference between the APD score associated with the avatars participating in the multiuser event and the SPD score is outside of the threshold, the control circuitry of the server proceeds to step 506. If the difference between the APD score associated with the avatars participating in the multiuser event and the SPD score is not outside of the threshold, the control circuitry of the server proceeds back to step 502.

In some embodiments, at step 506, the control circuitry of the server modulates at least one subset of avatars participating in the multiuser event to cause a reduction in the difference between the APD score associated with the avatars participating in the multiuser event and the SPD score. In some approaches, at step 506, the control circuitry of the server proceeds to either step 508 or step 510 so as to modulate the at least one subset of avatars participating in the multiuser event. In some approaches, if the lobby/queue hybrid (e.g., lobby/queue hybrid 108) does not contain any avatar, the control circuitry of the server proceeds directly to step 510 to modulate the at least one subset of avatars participating in the multiuser event.

In some embodiments, at step 508, the control circuitry of the server selects an avatar that is not currently participating in the multiuser event for inclusion into the at least one subset of avatars participating in the multiuser event, wherein the selecting is based on an individual historical performance dynamics (IHPD) score of the avatar that is not currently participating in the multiuser event. In some instances, the control circuitry of the server retrieves the IHPD score from a curve representing the IHPD score of the selected avatar against the time of a past multiuser event. In some instances, the control circuitry of the server retrieves the IHPD score of the avatar from a curve representing the IHPD score averaged on the latest past multiuser events against the time of a multiuser event. In some approaches, at step 508, the control circuitry of the server proceeds to either step 512 or step 514.

In some embodiments, at step 510, the control circuitry of the server selects an avatar from the at least one subset of avatars participating in the multiuser event based on the individual actual performance dynamics (IAPD) score of the avatar. In some approaches, at step 510, the control circuitry of the server proceeds to either step 516 or step 518.

In some embodiments, at step 512, the control circuitry of the server replaces an avatar from the at least one subset of avatars participating in the multiuser event by the selected avatar. In some approaches, at step 512, the control circuitry of the server proceeds back to step 502.

In some embodiments, at step 514, the control circuitry of the server adds the selected avatar into the at least one subset of avatars participating in the multiuser event. In some approaches, at step 514, the control circuitry of the server proceeds back to step 502.

In some embodiments, at step 516, the control circuitry of the server modulates the participation of the selected avatar in the multiuser event. In some embodiments, at step 516, the control circuitry of the server restricts, to a sub-range of actions, the default range of actions that the avatar can perform at any time during the multiuser event in absence of a restriction or an extension, implemented by the control circuitry of the server, on the default range of actions. In some instances, the server restricts, for a duration, actions related to the mobility of the selected avatar: the server immobilizes, for a duration, the selected avatar at a fixed position within a virtual venue of the multiuser event (e.g., a jail-type venue or the virtual venue where the users participating in the multiuser event perform actions); or confines the selected avatar within a portion of the virtual venue (where the avatars participating in the multiuser event perform actions) while allowing the selected avatar to perform any actions of the default range other than the actions related to the mobility of the selected user. In some approaches, the server restricts, for a duration, actions involving an interaction between the selected avatar and an object (e.g., a ball, a puck, a racquet, a stick, skates, a weapon, ammunitions, etc.) that can effect directly or indirectly the outcome of the multiuser event (e.g., number of goals scored, number of kills). In some instances, the server prevents, for a duration, the selected avatar from interacting with the object. In some approaches, the server prevents the user controlling the avatar participating in the multiuser event from viewing the course of the multiuser event or entering inputs to give instructions to the avatar participating in the multiuser event.

In some embodiments, at step 516, the control circuitry of the server extends, to a supra-range of actions, the default range of actions that the selected avatar can perform at any time during the multiuser event in absence of a restriction or an extension, implemented by the control circuitry of the server, on the default range of actions. In some instances, the server extends, for a duration, actions related to the mobility of the selected avatar: the server teleports the selected avatar (when requested by the user controlling the selected avatar) to a place of interest. In some approaches, the server extends, for a duration, actions involving an interaction between the selected avatar and an object (e.g., a ball, a puck, a racquet, a stick, skates, a weapon, ammunitions, etc.) that can effect directly or indirectly the outcome of the multiuser event (e.g., number of goals scored, number of kills). In some instances, the server imparts the selected avatar the power of attracting the object (when enabled by the user controlling the selected avatar) when the distance between the selected avatar and the object is below a threshold. In some approaches, at step 516, the control circuitry of the server proceeds back to step 502.

In some embodiments, at step 518, the control circuitry of the server modulates the IAPD score of the selected avatar. In some embodiments, at step 518, the control circuitry of the server increases the IAPD score of the selected avatar. In some embodiments, at step 518, the control circuitry of the server increases the IAPD score of the selected avatar. In some approaches, at step 518, the control circuitry proceeds to step 520.

In some embodiments, at step 520, the control circuitry of the server modulates a skill score of the selected avatar. In some approaches, at step 520, the control circuitry of the server modulates a skill score of the selected avatar by modulating an area of a geometric shape located in a spider diagram (e.g., spider diagrams 152, 202 and 208), wherein each vertex of the geometric shape corresponds to a level of a skill. In some instances, at step 520, the control circuitry of the server increases the area of the geometric area to increase the skill score of the selected avatar. In some instances, at step 520, the control circuitry of the server decreases the area of the geometric area to decrease the skill score of the selected avatar. In some approaches, at step 520, the control circuitry of the server proceeds back to step 502.

In some embodiments, the control circuitry of the server determines a reduction in the difference between the APD score associated with the avatars participating in the multiuser event and the SPD score, associated with the simulating of any one of steps 512, 514, 516 and 520. In some approaches, the control circuitry of the server then selects the highest reduction in the difference between the APD score associated with the avatars participating in the multiuser event and the SPD score. Alternatively, the control circuitry of the server selects the smallest reduction in the difference between the APD score associated with the avatars participating in the multiuser event and the SPD score, wherein the lowest reduction allows the difference to be below the threshold. In some approaches, the control circuitry of the server implements the step associated with the selected reduction in the difference between the APD score associated with the avatars participating in the multiuser event and the SPD score.

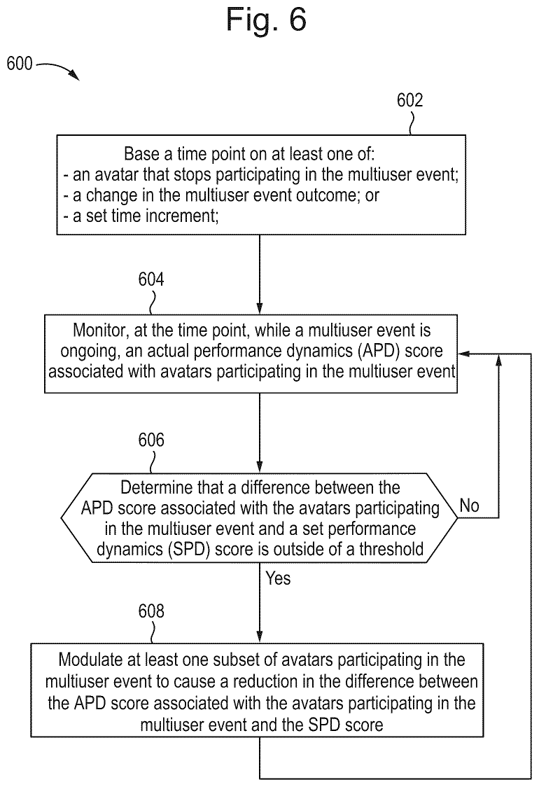

FIG. 6 represents a flowchart describing an example 600 for improving the engagement, with a multiuser event, of the users controlling each an avatar participating in the multiuser event, in accordance with some implementations of the disclosure.

In some embodiments, prior to the start of the multiuser event (e.g., a soccer match depicted e.g., in first screen 102 or in second screen 132), control circuitry of the server (e.g., server 804) selects a predefined curve representing a set performance dynamics (SPD) score associated with the participating avatars against the time of the multiuser event (from a series of predefined curves representing the SPD score associated with the participating avatars against the time of a multiuser event). For the sake of clarity, the SPD score of the avatars participating in the multiuser event is called hereinafter the SPD score. In some embodiments, prior to the start of the multiuser event (e.g., a soccer match depicted e.g., in first screen 102), the control circuitry of the server selects avatars from a lobby/queue hybrid (e.g., lobby/queue hybrid 108) that are to become participating avatars during the multiuser event and forms at least one subset of avatars participating in the multiuser event. A subset of avatars participating in the multiuser event is a team e.g., Team 1 represented by triangle-shaped players (e.g., player 110) or Team 2 represented by square-shaped players (e.g., player 112). In some approaches, when there is an insufficient number of users in the lobby/queue hybrid (compared to the number of users requested by the multiuser event), the control circuitry of the server forms only a single subset of avatars participating in the multiuser event based on the avatars from the lobby/queue hybrid. Any avatar of the single subset of avatars participating in the multiuser event is controlled by a user using a user device connected to the server via a communication network (e.g., local network or remote network). The control circuitry of the server then generates another subset of avatars participating in the multiuser event and controls the performance of the other subset of avatars participating in the multiuser event. In some instances, in order to offset the insufficient number of avatars in the lobby/queue hybrid, a non-transitory computer-readable medium comprises instructions that when executed by the control circuitry of the server causes the control circuitry of the server to generate at least one avatar participating in the multiuser event and the curve representing the IHPD score of the at least one avatar participating in the multiuser event against the time of a multiuser event and to control the performance of the at least one avatar participating in the multiuser event during the multiuser event. Irrespective of whom (e.g., several users or the server) controls a subset, both subsets compete against each other.

In some approaches, when there is a sufficient number of avatars in the lobby/queue hybrid, the control circuitry of the server forms two subsets of avatars participating in the multiuser event based on the avatars from the lobby/queue hybrid: each avatar is controlled by a user using a user device connected to the server via a communication network (e.g., local network or remote network) and both subsets of avatars participating in the multiuser event compete against each other. The two subsets are different from each other and do not share a single avatar.

In some approaches, when there is an insufficient number of avatars in the lobby/queue hybrid (compared to the number of avatars requested by the multiuser event), the control circuitry of the server forms two subsets of avatars participating in the multiuser event which both comprise avatars, from the lobby/queue hybrid, controlled by users, and avatars, generated by the control circuitry of the server, whose performance during the multiuser event is controlled by the server. In some approaches, the control circuitry of the server adjusts the selected SPD score-related curve based on the IHPD scores of the avatars of the at least one subset of avatars participating in the multiuser event. The two subsets are different from each other and do not share a single avatar.

In some embodiments, at step 602, the control circuitry of the server bases a time point on at least one of: an avatar that stops participating in the multiuser event as e.g., the user controlling the departing avatar leaves the multiuser event, the elimination of the avatar from the multiuser event, a change in the multiuser event outcome or a set time increment. In some instances, the change in the multiuser event outcome is multiuser-dependent. If the multiuser event is a soccer match, the change in the multiuser event outcome can be e.g., a goal scored by an avatar participating in the soccer match, a red card received by an avatar participating in the soccer match, an injured avatar participating in the soccer match. If the multiuser event is a shooter video game match, the change in the multiuser event outcome can be e.g., a target eliminated, the injuring or the killing of an avatar participating in the shooter video game match.

In some embodiments, at step 604, the control circuitry of the server monitors, at the time point, while a multiuser event is ongoing, an actual performance dynamics (APD) score associated with avatars participating in the multiuser event.

In some embodiments, at step 606, the control circuitry of the server determines that a difference between the APD score associated with the avatars participating in the multiuser event and a set performance dynamics (SPD) score is outside of a threshold. In some embodiments, at step 606, the control circuitry of the server determines that a difference between the APD score associated with the avatars participating in the multiuser event and a set performance dynamics (SPD) score is outside of a threshold by determining the APD score associated with the avatars participating in the multiuser event and the SPD score at a same time point. In some approaches, at step 606, the control circuitry of the server sets the threshold as being a product of a figure ‘n’ by the SPD score by setting the figure ‘n’ to a value between 0 and 1 while the control circuitry of the server retrieves the SPD score from the selected predefined SPD score-related curve. If the difference between the APD score associated with the users participating in the multiuser event and the SPD score is outside of the threshold, the control circuitry of the server proceeds to step 608. If the difference between the APD score associated with the avatars participating in the multiuser event and the SPD score is not outside of the threshold, the control circuitry of the server proceeds back to step 602.

In some embodiments, at step 608, the control circuitry of the server modulates at least one subset of avatars participating in the multiuser event to cause a reduction in the difference between the APD score associated with the avatars participating in the multiuser event and the SPD score. In some embodiments, at step 608, the control circuitry of the server modulates at least one subset of avatars participating in the multiuser event to cause a reduction in the difference between the APD score associated with the avatars participating in the multiuser event and the SPD score, by performing any one of steps 512, 514, 516 and 520 (depicted in FIG. 5). In some embodiments, at step 608, the control circuitry of the server modulates, prior to the occurrence of the predicted time point, at least one subset of avatars participating in the multiuser event to cause a reduction in the difference between the APD score associated with the avatars participating in the multiuser event and the SPD score, by simulating any one of steps 512, 514, 516 and 520 (depicted in FIG. 5), selecting any one of steps 512, 514, 516 and 520 to have the highest reduction and implementing the selected step. Alternatively, at step 608, the control circuitry of the server modulates, prior to the occurrence of the predicted time point, at least one subset of users participating in the multiuser event to cause a reduction in the difference between the APD score associated with the avatars participating in the multiuser event and the SPD score, by simulating any one of steps 512, 514, 516 and 520 (depicted in FIG. 5), selecting any one of steps 512, 514, 516 and 520 to have the lowest reduction allowing the difference to be below the threshold and implementing the selected step. In some approaches, at step 608, the control circuitry proceeds back to step 604.

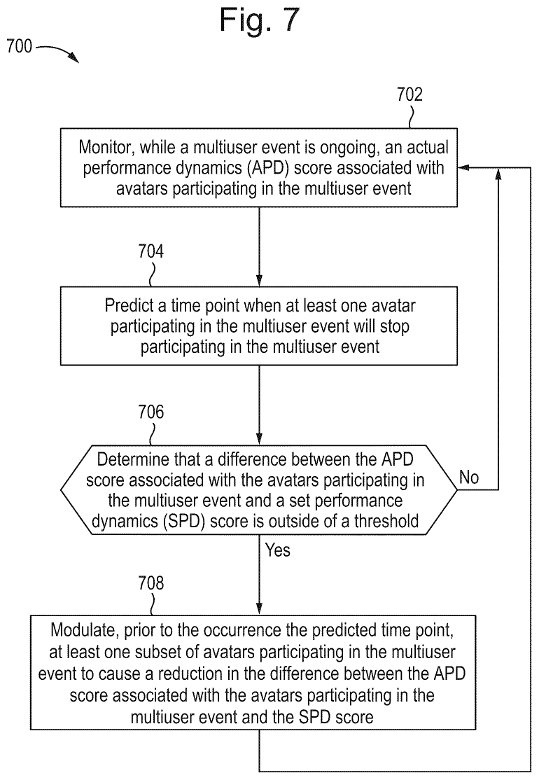

FIG. 7 depicts a flowchart describing an example 700 for improving the engagement, with a multiuser event, of the users controlling each an avatar participating in the multiuser event, in accordance with some implementations of the disclosure.

In some embodiments, prior to the start of the multiuser event (e.g., a soccer match depicted e.g., in first screen 102 or in second screen 132), control circuitry of the server (e.g., server 804) selects a predefined curve representing a set performance dynamics (SPD) score associated with the participating avatars against the time of the multiuser event (from a series of predefined curves representing the SPD score associated with the participating avatars against the time of a multiuser event). For the sake of clarity, the SPD score of the avatars participating in the multiuser event is called hereinafter the SPD score. In some embodiments, prior to the start of the multiuser event (e.g., a soccer match depicted e.g., in first screen 102), the control circuitry of the server selects avatars from a lobby/queue hybrid (e.g., lobby/queue hybrid 108) that are to become participating avatars during the multiuser event and forms at least one subset of avatars participating in the multiuser event. A subset of avatars participating in the multiuser event is a team e.g., Team 1 represented by triangle-shaped players (e.g., player 110) or Team 2 represented by square-shaped players (e.g., player 112).

In some approaches, when there is an insufficient number of avatars in the lobby/queue hybrid (compared to the number of avatars requested by the multiuser event), the control circuitry of the server forms only a single subset of avatars participating in the multiuser event based on the avatars, from the lobby/queue hybrid, each controlled by a user. Any avatar of the single subset of avatars participating in the multiuser event is controlled by a user using a user device connected to the server via a communication network (e.g., local network or remote network). The control circuitry of the server then generates another subset of avatars participating in the multiuser event and controls the performance of the other subset of avatars participating in the multiuser event. In some instances, in order to offset the insufficient number of avatars in the lobby/queue hybrid, a non-transitory computer-readable medium comprises instructions that when executed by the control circuitry of the server causes the control circuitry of the server to generate at least one avatar participating in the multiuser event and the curve representing the IHPD score of the at least one avatar participating in the multiuser event against the time of a multiuser event and to control the performance of the at least one avatar participating in the multiuser event during the multiuser event. Irrespective of whom (e.g., several users or the server) controls a subset, both subsets compete against each other.

In some approaches, when there is a sufficient number of users in the lobby/queue hybrid, the control circuitry of the server forms two subsets of avatars participating in the multiuser event based on the avatars, from the lobby/queue hybrid, each controlled by a user: each avatar is controlled by a user using a user device connected to the server via a communication network (e.g., local network or remote network) and both subsets of avatars participating in the multiuser event compete against each other. The two subsets are different from each other and do not share a single avatar.

In some approaches, when there is an insufficient number of avatars in the lobby/queue hybrid (compared to the number of avatars requested by the multiuser event), the control circuitry of the server forms two subsets of avatars participating in the multiuser event which both comprise avatars, from the lobby/queue hybrid, each controlled by a user, and avatars, generated by the control circuitry of the server, whose performance during the multiuser event is controlled by the server. In some approaches, the control circuitry of the server adjusts the selected SPD score-related curve based on the IHPD scores of the avatars of the at least one subset of avatars participating in the multiuser event. The two subsets are different from each other and do not share a single avatar.

In some embodiments, at step 702, the control circuitry of the server monitors, while a multiuser event is ongoing, an actual performance dynamics (APD) score associated with avatars participating in the multiuser event. The term ‘monitor, while a multiuser event is ongoing, an APD score associated with avatars participating in the multiuser event’ should be understood to mean to determine, at at least one time point during the multiuser event, the APD score associated with avatars participating in the multiuser event.

In some embodiments, at step 704, the control circuitry of the server predicts a time point when at least one avatar participating in the multiuser event will stop participating in the multiuser event.

In some embodiments, at step 706, the control circuitry of the server determines that a difference between the APD score associated with the avatars participating in the multiuser event and a set performance dynamics (SPD) score is outside of a threshold. In some embodiments, at step 706, the control circuitry of the server determines that a difference between the APD score associated with the avatars participating in the multiuser event and a set performance dynamics (SPD) score is outside of a threshold by determining the APD score associated with the avatars participating in the multiuser event and the SPD score at a same time point. In some approaches, at step 706, the control circuitry of the server sets the threshold as being a product of a figure ‘n’ by the SPD score by setting the figure ‘n’ to a value between 0 and 1 while the control circuitry of the server retrieves the SPD score from the selected predefined SPD score-related curve. If the difference between the APD score associated with the avatars participating in the multiuser event and the SPD score is outside of the threshold, the control circuitry of the server proceeds to step 706. If the difference between the APD score associated with the avatars participating in the multiuser event and the SPD score is not outside of the threshold, the control circuitry of the server proceeds back to step 702.

In some embodiments, at step 708, the control circuitry of the server modulates, prior to the occurrence of the predicted time point, at least one subset of avatars participating in the multiuser event to cause a reduction in the difference between the APD score associated with the users participating in the multiuser event and the SPD score. In some embodiments, at step 708, the control circuitry of the server modulates, prior to the occurrence of the predicted time point, at least one subset of avatars participating in the multiuser event to cause a reduction in the difference between the APD score associated with the avatars participating in the multiuser event and the SPD score, by performing any one of steps 512, 514, 516 and 520 (depicted in FIG. 5). In some embodiments, at step 708, the control circuitry of the server modulates, prior to the occurrence of the predicted time point, at least one subset of avatars participating in the multiuser event to cause a reduction in the difference between the APD score associated with the avatars participating in the multiuser event and the SPD score, by simulating any one of steps 512, 514, 516 and 520 (depicted in FIG. 5), selecting any one of steps 512, 514, 516 and 520 to have the highest reduction and implementing the selected step. Alternatively, at step 708, the control circuitry of the server modulates, prior to the occurrence of the predicted time point, at least one subset of avatars participating in the multiuser event to cause a reduction in the difference between the APD score associated with the avatars participating in the multiuser event and the SPD score, by simulating any one of steps 512, 514, 516 and 520 (depicted in FIG. 5), selecting any one of steps 512, 514, 516 and 520 to have the lowest reduction allowing the difference to be below the threshold and implementing the selected step. In some approaches, at step 708, the control circuitry proceeds back to step 702.

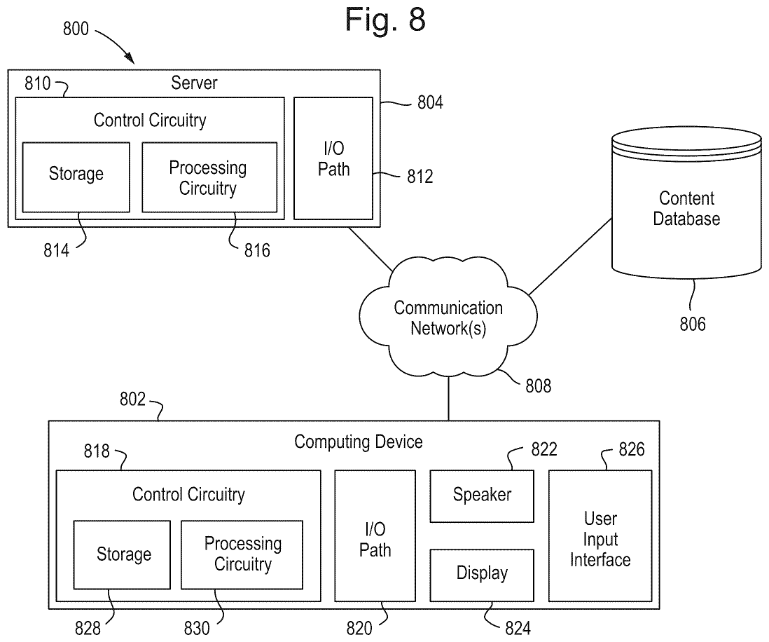

FIG. 8 illustrates a block diagram showing components of an example system 800 for improving the engagement, with a multiuser event, of users controlling each an avatar participating in the multiuser event, in accordance with some implementations of the disclosure.

Although FIG. 8 shows system 800 as including a number and configuration of individual components, in some examples, any number of the components of system 800 is combined and/or integrated as one device, e.g., as a user device used by a user to control an avatar participating in a multiuser event). System 800 includes computing device 802 (e.g., a user device used by a user to control an avatar participating in a multiuser event), server 804 (e.g., server hosting multiuser events such as online live multiuser events), and content database 806 (e.g., database containing metadata about e.g., multiuser events, users controlling avatars), each of which is communicatively coupled to communication network 808, which is the Internet or any other suitable network or group of networks. In some examples, system 800 excludes server 804, and functionality that would otherwise be implemented by server 804 is instead implemented by other components of system 800, such as computing device 802. In still other examples, server 804 works in conjunction with computing device 802 to implement certain functionality described herein in a distributed or cooperative manner.

Server 804 includes control circuitry 810 and input/output (hereinafter “I/O”) path 812, and control circuitry 810 includes storage 814 and processing circuitry 816. Computing device 802, which can be a personal computer, a laptop computer, a tablet computer, a smartphone, a smart television, a smart speaker, or any other type of computing device, includes control circuitry 818, I/O path 820, speaker 822, display 824, and user input interface 826, which in some examples provides a user selectable option for enabling and disabling the display of modified closed captions. Control circuitry 818 includes storage 828 and processing circuitry 830. Control circuitry 810 and/or 818 is based on any suitable processing circuitry such as processing circuitry 816 and/or 830. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and includes a multi-core processor (e.g., dual-core, quad-core, hexa-core, or any suitable number of cores). In some examples, processing circuitry is distributed across multiple separate processors, for example, multiple of the same type of processors (e.g., two Intel Core i9 processors) or multiple different processors (e.g., an Intel Core i7 processor and an Intel Core i9 processor).

Each of storage 814, storage 828, and/or storages of other components of system 800 (e.g., storages of content database 806, and/or the like) is an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 814, storage 828, and/or storages of other components of system 800 is used to store various types of content, metadata, and or other types of data. Non-volatile memory also is used (e.g., to launch a boot-up routine and other instructions). Cloud-based storage is used to supplement storages 814, 828 or instead of storages 814, 828. In some examples, control circuitry 810 and/or 818 executes instructions for an application stored in memory (e.g., storage 814 and/or 828). Specifically, control circuitry 810 and/or 818 is instructed by the application to perform the functions discussed herein. In some implementations, any action performed by control circuitry 810 and/or 818 is based on instructions received from the application. For example, the application is implemented as software or a set of executable instructions that is stored in storage 814 and/or 828 and executed by control circuitry 810 and/or 818. In some examples, the application is a client/server application where only a client application resides on computing device 802, and a server application resides on server 804.

The application is implemented using any suitable architecture. For example, it is a stand-alone application wholly implemented on computing device 802. In such an approach, instructions for the application are stored locally (e.g., in storage 828), and data for use by the application is downloaded on a periodic basis (e.g., from an out-of-band feed, from an Internet resource, or using another suitable approach). Control circuitry 818 retrieves instructions for the application from storage 828 and process the instructions to perform the functionality described herein. Based on the processed instructions, control circuitry 818 determines what action to perform when input is received from user input interface 826.

In client/server-based examples, control circuitry 818 includes communication circuitry suitable for communicating with an application server (e.g., server 804) or other networks or servers. The instructions for carrying out the functionality described herein are stored on the application server. Communication circuitry includes a cable modem, an Ethernet card, or a wireless modem for communication with other equipment, or any other suitable communication circuitry. Such communication involves the Internet or any other suitable communication networks or paths (e.g., communication network 808). In another example of a client/server based application, control circuitry 818 runs a web browser that interprets web pages provided by a remote server (e.g., server 804). For example, the remote server stores the instructions for the application in a storage device. The remote server processes the stored instructions using circuitry (e.g., control circuitry 810) and/or generates displays. Computing device 802 receives the displays generated by the remote server and displays the content of the displays locally via display 824. This way, the processing of the instructions is performed remotely (e.g., by server 804) while the resulting displays are provided locally on computing device 802. Computing device 802 receives inputs from the user via input interface 826 and transmits those inputs to the remote server for processing and generating the corresponding displays.

A user sends instructions, e.g., to view an interactive media content item and/or selects one or more programming options of the interactive media content item, to control circuitry 810 and/or 818 using user input interface 826. User input interface 826 is any suitable user interface, such as a remote control, trackball, keypad, keyboard, touchscreen, touchpad, stylus input, joystick, speech recognition interface, gaming controller, or other user input interfaces. User input interface 826 is integrated with or combined with display 824, which can be a monitor, a television, a liquid crystal display (LCD), an electronic ink display, or any other equipment suitable for displaying visual images.

Server 804 and computing device 802 transmits and receives content and data via I/O path 812 and 820, respectively. For instance, I/O path 812 and/or I/O path 820 includes a communication port(s) configured to transmit and/or receive (for instance to and/or from content database 806), via communication network 808, content item identifiers, content metadata, natural language queries, and/or other data. Control circuitry 810, 818 is used to send and receive commands, requests, and other suitable data using I/O paths 812, 820. I/O paths 812 of server 804 and I/O paths 820 of computing device 802 each comprises I/O circuitry e.g., network interface, port, bus, wire.

1. A method for modulating dynamics of multiuser events, the method comprising:
monitoring, while a multiuser event is ongoing, an actual performance dynamics (APD) score associated with avatars participating in the multiuser event;
determining that a difference between the APD score associated with the avatars participating in the multiuser event and a set performance dynamics (SPD) score is outside of a threshold; and
based on the difference between the APD score and the SPD score being outside of the threshold, modulating at least one subset of avatars participating in the multiuser event to cause a reduction in the difference between the APD score and the SPD score.

2. The method of claim 1, wherein:
the monitoring the APD score associated with the avatars participating in the multiuser event comprises determining the APD score associated with the avatars participating in the multiuser event at a time point of the multiuser event, the time point being based on at least one of:
an avatar that stops participating in the multiuser event;
a change in the multiuser event; or
a set time increment.

3. The method of claim 2, wherein the determining the APD score associated with the avatars participating in the multiuser event comprises:
determining, at the time point, individual actual performance dynamics (IAPD) scores, each IAPD score relating to an avatar participating in the multiuser event.

4. The method of claim 1, wherein the modulating the at least one subset of avatars participating in the multiuser event comprises:
selecting an avatar that is not currently participating in the multiuser event for inclusion into the at least one subset of avatars participating in the multiuser event, wherein the selecting is based on an individual historical performance dynamics (IHPD) score of the avatar that is not currently participating in the multiuser event.

5. The method of claim 1, wherein the modulating the at least one subset of avatars participating in the multiuser event comprises:
selecting an avatar from the at least one subset of avatars based on an IAPD score of the avatar; and
modulating the participation of the selected avatar in the multiuser event; or
modulating the IAPD score of the selected avatar.

6. The method of claim 5, wherein the modulating the IAPD score of the selected avatar comprises:
determining a skill score contributing to the selected avatar's IAPD score; and
modulating the skill score of the selected avatar.

7. The method of claim 1, wherein:
the SPD score is based on an SPD curve defined by a set of predefined SPD values as function of time points of the multiuser event.

8. The method of claim 1, wherein:
the determining that the difference between the APD score associated with the avatars participating in the multiuser event and the SPD score is outside of the threshold comprises at least one of:
(i) predicting a time point when at least one avatar of a subset of avatars participating in the multiuser event will stop participating in the multiuser event; and
the modulating the at least one subset of avatars participating in the multiuser event occurs before the predicted time point; or
(ii) predicting a duration before an end of the multiuser event; and
the modulating the at least one subset of avatars participating in the multiuser event occurs within the predicted duration.

9. The method of claim 1, wherein:
the APD score is based on individual actual performance dynamics (IAPD) scores associated with respective subsets of avatars participating in the multiuser event; and
each IAPD score of an avatar is based at least on a beneficial action and/or a detrimental action performed by the avatar.

10. The method of claim 1, wherein:
the SPD score is based on individual historical performance dynamics (IHPD) scores associated with respective subsets of avatars participating in the multiuser event.

11. A system for modulating dynamics of multiuser events, the system comprising:
control circuitry configured to:
monitor, while a multiuser event is ongoing, an actual performance dynamics (APD) score associated with avatars participating in the multiuser event;
determine that a difference between the APD score associated with the avatars participating in the multiuser event and a set performance dynamics (SPD) score is outside of a threshold; and
based on the difference between the APD score and the SPD score being outside of the threshold, modulate at least one subset of avatars participating in the multiuser event to cause a reduction in the difference between the APD score and the SPD score.

12. The system of claim 11, wherein:
the control circuitry is further configured to monitor the APD score associated with the avatars participating in the multiuser event by determining the APD score associated with the avatars participating in the multiuser event at a time point of the multiuser event, the time point being based on at least one of:
an avatar that stops participating in the multiuser event;
a change in the multiuser event; or
a set time increment.

13. The system of claim 12, wherein the control circuitry is further configured to determine the APD score associated with the avatars participating in the multiuser event by:
determining, at the time point, individual actual performance dynamics (IAPD) scores, each IAPD score relating to an avatar participating in the multiuser event.

14. The system of claim 11, wherein the control circuitry is further configured to modulate the at least one subset of avatars participating in the multiuser event by:
selecting an avatar that is not currently participating in the multiuser event for inclusion into the at least one subset of avatars participating in the multiuser event, wherein the selecting is based on an individual historical performance dynamics (IHPD) score of the avatar that is not currently participating in the multiuser event.

15. The system of claim 11, wherein the control circuitry is further configured to modulate the at least one subset of avatars participating in the multiuser event by:
selecting an avatar from the at least one subset of avatars based on an IAPD score of the avatar; and
modulating the participation of the selected avatar in the multiuser event; or
modulating the IAPD score of the selected avatar.

16. The system of claim 15, wherein the control circuitry is further configured to modulate the IAPD score of the selected avatar by:
determining a skill score contributing to the selected avatar's IAPD score; and
modulating the skill score of the selected avatar.

17. The system of claim 11, wherein:
the SPD score is based on an SPD curve defined by a set of predefined SPD values as function of time points of the multiuser event.

18. The system of claim 11, wherein:
the control circuitry is further configured to determine that the difference between the APD score associated with the avatars participating in the multiuser event and the SPD score is outside of the threshold by at least one of:
(i) predicting a time point when at least one avatar of a subset of avatars participating in the multiuser event will stop participating in the multiuser event; and
having the control circuitry further configured to modulate the at least one subset of avatars participating in the multiuser event before the predicted time point; or
(ii) predicting a duration before an end of the multiuser event; and
having the control circuitry further configured to modulate the at least one subset of avatars participating in the multiuser event within the predicted duration.

19. The system of claim 11, wherein:
the APD score is based on individual actual performance dynamics (IAPD) scores associated with respective subsets of avatars participating in the multiuser event; and
each IAPD score of an avatar is based at least on a beneficial action and/or a detrimental action performed by the avatar.

20. The system of claim 11, wherein:
the SPD score is based on individual historical performance dynamics (IHPD) scores associated with respective subsets of avatars participating in the multiuser event.

21-50. (canceled)
